(19) United States
(12) Patent Application Publication
(10) Pub. No.: US 2023/0019839 A1
(43) Pub. Date: Jan. 19, 2023

(54) CONSTRUCTING AND OPERATING AN ARTIFICIAL RECURRENT NEURAL NETWORK

(71) Applicant: INAIT SA, Lausanne (CH)

(72) Inventor: Henry Markram, Lausanne (CH)

(21) Appl. No.: 17/783,978

(22) PCT Filed: Dec. 11, 2020
(86) PCT No.: PCT/EP2020/085762

§ 371 Date: Jun. 9, 2022

Related U.S. Application Data
(60) Provisional application No. 62/946,733, filed on Dec. 11, 2019.

(51) Int. Cl. G06N 3/04; G06N 3/063

(52) U.S. Cl. CPC G06N 3/049; G06N 3/0635

(57) ABSTRACT

Methods, systems, and apparatus, including computer programs encoded on a computer storage medium, for constructing and operating a recurrent artificial neural network. In one aspect, a method is for constructing nodes of an artificial recurrent neural network that mimics a target brain tissue. The method includes setting a total number of nodes in the artificial recurrent neural network, setting a number of classes and sub-classes of the nodes in the artificial recurrent neural network, setting structural properties of nodes in each class and sub-class, wherein the structural properties determine temporal and spatial integration of computation as a function of time as the node combines inputs, setting functional properties of nodes in each class and sub-class, wherein the functional properties determine activation, integration, and response functions as a function of time, setting a number of nodes in each class and sub-class of nodes, setting a level of structural diversity of each node in each class and sub-class of nodes and a level of functional diversity of each node in each class and sub-class of nodes, setting an orientation of each node, and setting a spatial arrangement of each node in the artificial recurrent neural network, wherein the spatial arrangement determines which nodes are in communication in the artificial recurrent neural network.

### CLAIM OF PRIORITY

This application claims the priority of U.S. Patent Application No. 62/946,733, filed 11 Dec. 2019, which is incorporated herein by reference in its entirety.

### TECHNICAL FIELD

This specification relates to the methods and processes for constructing and operating a recurrent artificial neural network that acts as a “neurosynaptic computer.” A neurosynaptic computer is based on a computing paradigm that mimics computing in the brain. A neurosynaptic computer can use a symbolic computer language that processes information as cognitive algorithms composed of a hierarchical set of decisions. A neurosynaptic computer can take an input a wide range of data types, convert the data into binary code for input, encode the binary code into a sensory code, process the sensory code by simulating a response to the sensory input using a brain processing unit, encode the decisions made in a neural code, and decode the neural code to generate a target output. A paradigm for computing is described together with methods and processes to adapt this new paradigm for the construction and operation of the recurrent artificial neural network. The computing paradigm is based on a neural code, a symbolic computer language. The neural code encodes a set of decisions made by the brain processing unit and can be used to represent the results of a cognitive algorithm. A neurosynaptic computer can be implemented in software operating on conventional digital computers and implemented in hardware running on neuromorphic computing architectures. A neurosynaptic computer can be used for computing, storage and communication and is applicable for the development of a wide range of scientific, engineering and commercial applications.

### SUMMARY

This specification describes technologies relating to constructing and operating a recurrent artificial neural network.

In general, one innovative aspect of the subject matter described in this specification can be embodied in methods of reading the output of an artificial recurrent neural network that comprises a plurality of nodes and edges connecting the nodes that include identifying one or more relatively complex root topological elements that each comprises a subset of the nodes and edges in the artificial recurrent neural network, identifying a plurality of relatively simpler topological elements that each comprises a subset of the nodes and edges in the artificial recurrent neural network, wherein the identified relatively simpler topological elements stand in a hierarchical relationship to at least one of the relatively complex root topological elements, generating a collection of digits, wherein each of the digits represents whether a respective of the relatively complex root topological elements and the relatively simpler topological elements is active during a window, and outputting the collection of digits.

This and other general methods and systems can include one or more of the following features. Identifying the relatively complex root topological elements can include determining that the relatively complex root topological elements are active when the recurrent neural network is responding to an input. Identifying the relatively simpler topological elements that stand in a hierarchical relationship to the relatively complex root topological elements can include inputting a dataset of inputs into the recurrent neural network, and determining that either activity or inactivity of the relatively simpler topological elements is correlated with activity of the relatively complex root topological elements. The method can also include defining criteria for determining if a topological element is active. The criteria for determining if the topological element is active can be based on activity of the nodes or edges included in the topological element. The method can also include defining criteria for determining if edges in the artificial recurrent neural network are active. Identifying the relatively simpler topological elements that stand in a hierarchical relationship to the relatively complex root topological elements can include decomposing the relatively complex root topological elements into a collection of topological elements. Identifying the relatively simpler topological elements that stand in a hierarchical relationship to the relatively complex root topological elements can include forming a list of topological elements into which the relatively complex root topological elements decompose, sorting the list from the most complex of the topological elements to the least complex of the topological elements, and, starting at the most complex of the topological elements, selecting the relatively simpler topological elements from the list for representation in the collection of digits based on the information content regarding the relatively complex root topological elements.

Selecting more complex of the topological elements from the list for representation in the collection of digits can include determining whether the relatively simpler topological elements selected from the list suffice to determine the relatively complex root topological elements, and in response to determining that the relatively simpler topological elements selected from the list suffice to determine the relatively complex root topological elements, selecting no further relatively simpler topological elements from the list.

In general, another innovative aspect of the subject matter described in this specification can be embodied in methods of reading the output of an artificial recurrent neural network that comprises a plurality of nodes and edges forming connections between the nodes. The methods can include defining computational results to be read from the artificial recurrent neural network. Defining the computational results can include defining criteria for determining if the edges in the artificial recurrent neural network are active, and defining a plurality of topological elements that each comprise a proper subset of the edges in the artificial recurrent neural network, and defining criteria for determining if each of the defined topological elements is active. The criteria for determining if each of the defined topological elements is active are based on activity of the edges included in the respective of the defined topological elements. An active topological element indicates that a corresponding computational result has been completed.

This and other general methods and systems can include one or more of the following features. The method can also include reading the completed computational results from the artificial recurrent neural network. The method can also include reading incomplete computational results from the artificial recurrent neural network. Reading an incomplete computational result can include reading activity of the edges that are included in a corresponding of the topological elements, wherein the activity of the edges does not satisfy the criteria for determining that the corresponding of the topological elements is active. The method can also include estimating a percent completion of a computational result, wherein estimating the percent completion comprises determining an active fraction of the edges that are included in a corresponding of the topological elements. The criteria for determining if the edges in the artificial recurrent neural network are active include requiring, for a given edge, that: a spike is generated by a node connected to that edge, the spike is transmitted by the edge to a receiving node, and the receiving node generates a response to the transmitted spike.

The criteria for determining if the edges in the artificial recurrent neural network are active includes a time window in which the spike is to be generated and transmitted and the receiving node is to generate the response. The criteria for determining if the edges in the artificial recurrent neural network are active includes a time window in which two nodes connected by the edge spike, regardless of which if the two nodes spikes first. Different criteria for determining if the edges in the artificial recurrent neural network are active can be applied to different of the edges. Defining computational results to be read from the artificial recurrent neural network can also include constructing functional graphs of the artificial recurrent neural network, including: defining a collection of time bins, creating a plurality of functional graphs of the artificial recurrent neural network, wherein each functional graph includes only nodes that are active within a respective of the time bins, and defining the plurality of topological elements based on the active of the edges in the functional graphs of the artificial recurrent neural network.

The can also include combining a first topological element that is defined in a first of the functional graphs with a second topological element that is defined in a second of the functional graphs. The first and the second of the functional graphs can include nodes that are active within different of the time bins. The method can also include including one or more global graph metrics or meta information in the computational results. Defining the computational results to be read from the artificial recurrent neural network can include selecting a proper subset of the plurality of topological elements to be read from the artificial recurrent neural network based on a number of times that each topological element is active during the processing of a single input and across a dataset of inputs. Selecting the proper subset of the plurality of topological elements can include selecting a first of the topological elements that is active for only a small fraction of the dataset of inputs and designating the first of the topological elements as indicative of an anomaly. Selecting the proper subset of the plurality of topological elements can include selecting topological elements to insure that the proper subset includes a predefined distribution of topological elements that are active for different fractions of the dataset of inputs. Defining the computational results to be read from the artificial recurrent neural network can also include selecting a proper subset of the plurality of topological elements to be read from the artificial recurrent neural network based on a hierarchical arrangement of the topological elements, wherein a first of the topological elements is identified as a root topological element and topological elements that contribute to the root topological element are selecting for the proper subset. The can also include identifying a plurality of root topological elements and selecting topological elements that contribute to the root topological elements for the proper subset.

In general, another innovative aspect of the subject matter described in this specification can be embodied in processes for selecting a set of elements that form a cognitive process in a recurrent neural network. These method can include identifying activity in the recurrent neural network that comports with relatively simple topological patterns, using the identified relatively simple topological patterns as a constraint to identify relatively more complex topological patterns of activity in the recurrent neural network, using the identified relatively more complex topological patterns as a constraint to identify relatively still more complex topological patterns of activity in the recurrent neural network, and outputting identifications of the topological patterns of activity that have occurred in the recurrent neural network.

This and other general methods and systems can include one or more of the following features. The identified activity in the recurrent neural network can reflect a probability that a decision has been made. Descriptions of the probabilities can be output. The probability can be determined based on a fraction of neurons in a group of neurons that are spiking. The method can also include outputting metadata describing a state of the recurrent neural network at times when the topological patterns of activity are identified.

In general, another innovative aspect of the subject matter described in this specification can be embodied in an artificial neural network system that includes means for generating a data environment, wherein the means for generating a data environment is configured to select data for input into a recurrent neural network, means for encoding the data selected by the means for generating the data environment for input into an artificial recurrent neural network, an artificial recurrent neural network coupled to receive the encoded data from the means for encoding, wherein the artificial recurrent neural network models a degree of the structural of a biological brain, an output encoder coupled to identify decisions made by the artificial recurrent neural network and compile those decisions into an output code, and means for translating the output code into actions.

This and other general methods and systems can include one or more of the following features. The artificial neural network system can also include means for learning configure to vary parameters in the artificial neural network system to achieve a desired result. The means for generating the data environment can also include one or more of a search engine configured to search one or more databases and output search results, a data selection manager configured to select a subset of the results output from the search engine, and a data preprocessor configured to preprocess the selected subset of the results output from the search engine.

The data preprocessor can be configured to adjust a size or dimensions of the selected subset of the results or create a hierarchy of resolution versions of the selected subset of the results or filtering the selected subset of the results, create statistical variants of the selected subset of the results.

The data preprocessor can be configured to create statistical variants of the selected subset of the results by introducing statistical noise, changing orientation of an image, cropping an image, or applying a clip mask to an image. The data preprocessor can be configured to apply a plurality of different filter functions to an image to generate a plurality of differently-filtered images. The artificial recurrent neural network can be coupled to receive the differently-filtered images at a same time.

The data preprocessor can be configured to contextually filter an image by processing a background of an image through a machine learning model to form a contextually-filtered image. The data preprocessor can be configured to perceptually filter the image by segmenting the image to obtain features of object and form a perceptually-filtered image. The data preprocessor can be configured to attention filter the image to identify salient information in the image and form an attention-filtered image. The artificial recurrent neural network can be coupled to receive the contextually-filtered image, the perceptually-filtered image, and attention-filtered image at a same time.

The means for encoding the data can include one or more of a timing encoder configured to encode the selected data in a pulse position modulation signal for input into neurons and/or synapses of the artificial recurrent neural network, or a statistical encoder configured to encode the selected data in statistical probabilities of activation of neurons and/or synapses in the artificial recurrent neural network, or a byte amplitude encoder configured to encode the selected data in proportional perturbations of neurons and/or synapses in the artificial recurrent neural network, or a frequency encoder configured to encode the selected data in frequencies of activation of neurons and/or synapses in the artificial recurrent neural network, or a noise encoder configured to encode the selected data in a proportional perturbation of a noise level of stochastic processes in the neurons and/or synapses in the artificial recurrent neural network, or a byte synapse spontaneous event encoder configured to encode the selected data in a either a set frequency or probability of spontaneous events in the neurons and/or synapses in the artificial recurrent neural network.

The means for encoding can be configured to map a sequence of bits in a byte to a sequential time point in a time series of events where ON bits produce a positive activation of neurons and/or synapses in the artificial recurrent neural network and OFF bits do not produce an activation of neurons and/or synapses in the artificial recurrent neural network. The positive activation of neurons and/or synapses can increase a frequency or probability of events in the neurons and/or synapses.

The means for encoding can be configured to map a sequence of bits in a byte to a sequential time point in a time series of events where ON bits produce a positive activation of neurons and/or synapses and OFF bits produce a negative activation of neurons and/or synapses in the artificial recurrent neural network. The positive activation of neurons and/or synapses increases a frequency or probability of events in the neurons and/or synapses and the negative activation of neurons and/or synapses decreases the frequency or probability of events in the neurons and/or synapses. The means for encoding can be configured to map a sequence of bits in a byte to a sequential time point in a time series of events where ON bits activate excitatory neurons and/or synapses and OFF bits activate inhibitory neurons and/or synapses in the artificial recurrent neural network. The artificial neural network system means for encoding can include a target generator configured to determine which neurons and/or synapses in the artificial recurrent neural network are to receive at least some of the selected data. The target generator can determine which neurons and/or synapses are to receive the selected data based on one or more of a region of the artificial recurrent neural network or a layer or cluster within a region of the artificial recurrent neural network or a specific voxel location of the neurons and/or synapses within a region of the artificial recurrent neural network, or a type of the neurons and/or synapses within the artificial recurrent neural network. The artificial recurrent neural network can be a spiking recurrent neural network.

In general, another innovative aspect of the subject matter described in this specification can be embodied in a method for constructing nodes of an artificial recurrent neural network that mimics a target brain tissue. The method can include setting a total number of nodes in the artificial recurrent neural network, setting a number of classes and sub-classes of the nodes in the artificial recurrent neural network, setting structural properties of nodes in each class and sub-class, wherein the structural properties determine temporal and spatial integration of computation as a function of time as the node combines inputs, setting functional properties of nodes in each class and sub-class, wherein the functional properties determine activation, integration, and response functions as a function of time, setting a number of nodes in each class and sub-class of nodes, setting a level of structural diversity of each node in each class and sub-class of nodes and a level of functional diversity of each node in each class and sub-class of nodes, setting an orientation of each node, and setting a spatial arrangement of each node in the artificial recurrent neural network, wherein the spatial arrangement determines which nodes are in communication in the artificial recurrent neural network.

This and other general methods and systems can include one or more of the following features. The total number of nodes and connections in the artificial recurrent neural network mimics a total number of neurons of a comparably sized portion of the target brain tissue. The structural properties of nodes include a branching morphology of the nodes and amplitudes and shapes of signals within the nodes, wherein the amplitudes and shapes of signals are set in accordance with a location of a receiving synapse on the branching morphology. The functional properties of nodes can include subthreshold and suprathreshold spiking behavior of the nodes. The number of classes and sub-classes of the nodes in the artificial recurrent neural network can mimic a number of classes and sub-classes of neurons in the target brain tissue.

The number of nodes in each class and sub-class of nodes in the artificial recurrent neural network can mimic a proportion of the classes and sub-classes of neurons in the target brain tissue. The level of structural diversity and the level of functional diversity of each node in the artificial recurrent neural network can mimic diversity of the neurons in the target brain tissue. The orientation of each node in the artificial recurrent neural network can mimic orientation of the neurons in the target brain tissue. The spatial arrangement of each node in the artificial recurrent neural network can mimic spatial arrangement of the neurons in the target brain tissue.

Setting the spatial arrangement can include setting layers of nodes and/or setting clustering of different classes or subclasses of nodes. Setting the spatial arrangement can include setting nodes for communication between different regions of the artificial recurrent neural network. A first of the regions can be designated for input of contextual data, a second of the regions can be designated for direct input, and a third of the regions can be designated for attention input.

In general, another innovative aspect of the subject matter described in this specification can be embodied in a method for constructing connections between nodes of an artificial recurrent neural network that mimics a target brain tissue. The method can include setting a total number of connections between the nodes in the artificial recurrent neural network, setting a number of sub-connections in the artificial recurrent neural network, wherein a collection of sub-connections forms a single connection between different types of nodes, setting a level of connectivity between the nodes in the artificial recurrent neural network, setting a direction of information transmission between the nodes in the artificial recurrent neural network, setting weights of the connections between the nodes in the artificial recurrent neural network, setting response waveforms in the connections between the nodes, wherein the responses are induced by a single spike in a sending node, setting transmission dynamics in the connections between the nodes, wherein the transmission dynamics characterize changing response amplitudes of an individual connections during a sequence of spikes from a sending node, setting transmission probabilities in the connections between the nodes, wherein the transmission probabilities characterize a likelihood that a response is generated by the sub-connections that form a given connection given a spike in a sending neuron, and setting spontaneous transmission probabilities in the connections between the nodes.

This and other general methods and systems can include one or more of the following features. The total number of connections in the artificial recurrent neural network can mimic a total number of synapses of a comparably sized portion of the target brain tissue. The number of sub-connections can mimic the number of synapses used to form single connections between different types of neurons in the target brain tissue. The level of connectivity between the nodes in the artificial recurrent neural network can mimic specific synaptic connectivity between the neurons of the target brain tissue. The method direction of information transmission between the nodes in the artificial recurrent neural network can mimic the directionality of synaptic transmission by synaptic connections of the target brain tissue. A distribution of the weights of the connections between the nodes can mimic weight distributions of synaptic connections between nodes in the target brain tissue. The method can include changing the weight of a selected of the connections between selected of the nodes. The method can include transiently shifting or changing the overall distribution of the weights of the connections between the nodes. The response waveforms can mimic location-dependent shapes of synaptic responses generated in a corresponding type of neuron of the target brain tissue. The method can include changing the response waveforms in a selected of the connections between selected of the nodes. The method can include transiently changing a distribution of the response waveforms in the connections between the nodes. The method can include changing the parameters of a function that determines the transmission dynamics in a selected of the connections between selected of the nodes. The method can include transiently changing a distribution of the parameters of functions that determine the transmission dynamics in the connections between the nodes. The method can include changing a selected of the transmission probabilities in a selected of the connections between nodes. The method can include transiently changing the transmission probabilities in the connections between nodes. The method can include changing a selected of the spontaneous transmission probabilities in a selected of the connections between nodes. The method can include transiently changing the spontaneous transmission probabilities in the connections between nodes.

In general, another innovative aspect of the subject matter described in this specification can be embodied in a method of improving a response of an artificial recurrent neural network. The method can include training the artificial recurrent neural network to increase a total response of all nodes in the artificial recurrent neural network during an input.

In general, another innovative aspect of the subject matter described in this specification can be embodied in a method of improving a response of an artificial recurrent neural network. The method can include training the artificial recurrent neural network to increase responses of the artificial recurrent neural network that comport with topological patterns of activity.

In general, another innovative aspect of the subject matter described in this specification can be embodied in a method of improving a response of an artificial recurrent neural network. The method can include training the artificial recurrent neural network to increase an amount of information stored in the artificial recurrent neural network, wherein the stored information characterizes time points in a time series or data files previously input into the artificial recurrent neural network.

In general, another innovative aspect of the subject matter described in this specification can be embodied in a method of improving a response of an artificial recurrent neural network. The method can include training the artificial recurrent neural network to increase a likelihood that subsequent inputs the artificial recurrent neural network are correctly predicted, wherein the subsequent inputs can be time points in a time series or data files.

At least one computer-readable storage medium can be encoded with executable instructions that, when executed by at least one processor, cause the at least one processor to perform operations comprising any of the above methods.

Particular embodiments of the subject matter described in this specification can be implemented so as to realize one or more of the following advantages. An information processing system can simultaneously process different types and combinations of data, executing arbitrarily complex mathematical operations on the data, encoding the brain operations in the form of a neural code, and decoding neural codes to generate arbitrarily complex outputs. The neural code comprises a set of values (binary and/or analog) that constitute a symbolic computer language that simplifies the representation and computational manipulation of arbitrarily complex information. Neural codes generated with such recurrent artificial neural networks provide a new class of technology for data storage, communications, and computing.

Such a recurrent artificial neural network can be used in a wide range of different ways. For example, neural codes can be designed to encode data in a highly compressed (lossy and lossless) form that is also encrypted. By encrypting data in neural codes, data can be analyzed securely without the need to decrypt the data first. Neural codes can be designed to encode telecommunication signals that are not only highly compressed and encrypted, but also display holographic properties to allow robust, rapid, and highly secure data transmission. Neural codes can be designed to represent a sequence of cognitive functions that execute a sequence of arbitrarily complex mathematical and/or logical operations on the data, thus providing general purpose computing. Neural codes can also be designed to represent a set of arbitrarily complex decisions of arbitrarily complex cognitive functions providing a new class of technology for Artificial Intelligence and Artificial General Intelligence.

Information can be processed by constructing and deconstructing hierarchies of entangled decisions to create arbitrarily complex cognitive algorithms. This can be adapted to operate on classical digital and/or neuromorphic computing architectures by adopting binary and/or analog symbols to represent the state of completeness of decisions made by a model of the brain. In some implementations, computing power can be increased by modelling the brain more closely than other neural networks. In other words, the recurrent artificial neural networks described herein put computer and AI systems on an opposite path of development as compared to modern digital computers and AI systems by moving towards the detail and complexity of the brain's structural and functional architecture. This computing architecture can be adapted to operate on classical digital computers, on analog neuromorphic computing systems, and can offer quantum computers a new way to map quantum states to information.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a schematic illustration of a neurosynaptic computer system.

FIG. 2 is a schematic representation of a data environment generator such as the data environment generator shown in FIG. 1.

FIG. 3 is a schematic representation of a sensory encoder such as the sensory encoder shown in FIG. 1.

FIG. 4 is a flowchart of a process for constructing a brain processing unit such as the brain processing unit shown in FIG. 1.

FIG. 5 is a flowchart of a process for constructing the nodes of a brain processing unit such as the brain processing unit shown in FIG. 1.

FIG. 6 is a flowchart of a process for constructing the connections of the nodes of a brain processing unit such as the brain processing unit shown in FIG. 1.

FIG. 7 is a schematic representation of a process for upgrading a brain processing unit such as the brain processing unit shown in FIG. 1.

FIG. 8 is a flowchart of a process for constructing a cognition encoder such as the cognition encoder shown in FIG. 1.

FIG. 9 is a schematic representation of neurotopological elements that have been constructed from a node and from combinations of nodes in a neural network.

FIG. 10 is a schematic representation of neurotopological elements that have been constructed from combinations of different components of a neural network.

FIG. 11 is a flowchart of a process for defining topological elements and associating topological units with computations.

FIG. 12 is schematic representation of a hierarchical organization of decisions within cognition.

FIG. 13 is a flowchart of a process for constructing a neural code.

FIG. 14 is a schematic representation of the process for constructing hierarchical neural codes.

FIG. 15 is an example of process for decoding neural codes into their target outputs.

FIG. 16 is a schematic representation of a learning adapter such as the learning adapter shown in FIG. 1

Like reference numbers and designations in the various drawings indicate like elements.

### DETAILED DESCRIPTION

A neurosynaptic computer encodes, processes and decodes information according to a cognitive computing paradigm that is modelled after how the brain operates. This paradigm is based on a key concept that cognition arises from arbitrarily complex hierarchies of decisions that are made and entangled with each other by arbitrarily combinations of arbitrarily elements in the brain. The central processing unit (CPU) of a neurosynaptic computer system is a spiking recurrent neural network that can in some implementations mimic aspects of the structural and functional architecture of brain tissue.

Other key features of this computing paradigm include

1. A recurrent neural network or equivalent implementation that generates a range of computations, which is synonymous with a range of decisions.

2. Cognitive computing capabilities arise from the ability to establish arbitrarily complex hierarchies of different combinations of decisions that are made by any type and number of elements of the brain, as they react to input.

3. Cognitive computing does not require knowledge of the specific computations performed by the neural elements to reach decisions; rather, it merely requires representation of the stages of each computation as states of a decision.

4. Cognitive computing exploits entanglement of states of a subset of decisions in a universe of decisions.

5. Cognitive computing is only fundamentally limited by the nature of the range of decisions that elements of the brain can make.

In this paradigm, a brain processing unit of a cognitive computer acts on input by constructing a large range of decisions and organizing these decision in a multi-level hierarchy. Decisions are identified as computations performed by elements in the brain processing. An understanding of the precise nature of the computations is not required. Instead the stage of completion of a computation is used to encode the state of decisions. Elements that perform computations that can be precisely represented mathematically are referred to as topological elements. Different cognitive algorithms arise from different combinations of decisions and the manner in which these decisions are networked together in hierarchies. The output is a symbolic computer language comprised of a set of decisions.

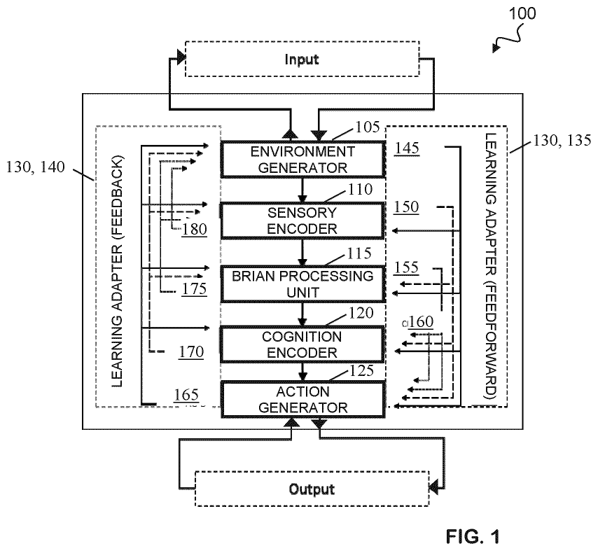

FIG. 1 is a schematic illustration of a neurosynaptic computer system 100. In the illustrated implementation, neurosynaptic computer system 100 includes a data environment generator 105, a sensory encoder 110, a recurrent artificial neural network brain processing unit (BPU) 115, a cognition encoder 120, an action generator 125, and a learning adapter 130 that governs learning and optimizations within and across each of these components.

Data environment generator 105 gathers and organizes data for processing by a brain processing unit such as BPU 115. Data environment generator 105 can include processing components such as a data and/or data stream search engine, a data selection manager, a module for loading the data (together acting as a classical extract, transform, load (i.e., ETL) process in computer science), a generator that constructs an environment of data, datasets and/or data streams and a preprocessor that performs data augmentation according to the computing requirements.

Sensory encoder 110 encodes data in a format that a recurrent artificial neural network brain processing unit can process. Sensory encoder 110 can include a sensory preprocessor, sensory encoder, sensory decomposer, a time manager, and an input manager.

Recurrent artificial neural network brain processing unit (BPU) 115 processes data by simulating the network response to the input. BPU 115 can include a spiking artificial recurrent neural network with a minimal set of specific structural and functional architectural requirements. In some implementations, the target architecture of a BPU can mimic the architecture of the actual brain, captured in accurate detail.

Cognition encoder 120 interprets activity in the BPU 115 and encodes the activity in a neural code. Cognition encoder 120 includes a set of sub-components identified unitary decisions made by the BPU, compiles a neural code from these decisions, and combines neural codes to form arbitrarily complex cognitive processes.

As discussed further below, a neurosynaptic computer system organizes decisions at different levels to construct arbitrarily complex cognitive algorithms. In other words, a elementary decisions can be organized into unitary decisions, cognitive operations, and cognitive functions to produce a cognitive algorithm. Elementary decisions are entangled to capture the range of the complexity of the computations performed by the neurosynaptic computer system. For example, elementary decisions are entangled to construct unitary decisions. Unitary decisions are entangled to construct successively higher levels in a hierarchy of decisions and arbitrarily complex cognitive algorithms. Cognition encoder 120 can identify and encode these decisions at different levels of the hierarchy in a neural code.

Action generator 125 includes decoders designed to decode neural codes into their target outputs. The decoders read and translate neural codes to perform the cognitive functions that they encode.

Learning adapter 130 governs learning and optimizations within and across each of these component. Learning adapter 130 is configured to set processes for optimizing and learning of the hyperparameters of each component of the system. Learning adapter 130 can include a feedforward learning adapter 135 and a feedback learning adapter. Feedforward learning adapter 135 can optimize hyperparameters based on, e.g., supervisory or other signals 145 from data environment generator 105, signals 150 from sensory encoder 110, signals 155 from BPU 115, and/or signals 160 from cognition encoder 120 to improve the operations of one or more of sensory encoder 110, BPU 115, cognition encoder 120, and/or action generator 125. Feedback learning adapter 135 can optimize hyperparameters based on, e.g., reward or other signals 165 from action generator 125, signals 170 from cognition encoder 120, signals 175 from BPU 115, and/or signals 180 from sensory encoder 110 to improve the operations of one or more of environment generator 105, sensory encoder 110, BPU 115, and/or cognition encoder 120.

In operation, neurosynaptic computer system 100 operates by following a sequence of operations of each component and adaptive learning interactions between components. The programming paradigm of a neurosynaptic computer allows different models for the configuration of parameters of each component. The different programming models allow different ways to exploit the symbolic representation of decisions. Various programming models can therefore be implemented to tailor a neurosynaptic computer for specific types of computing operations. A neurosynaptic computer can also self-optimize and learn the optimal programming model to match the target class of computing operations. Designing software and hardware applications with a neurosynaptic computer, involves setting the parameters of each component of the system and allowing the components to optimize on sample input data to produce the desired computing capabilities.

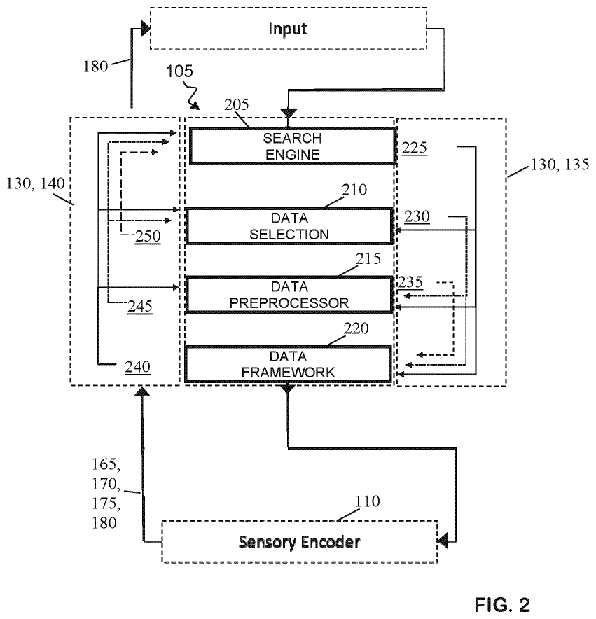

FIG. 2 is a schematic representation of a data environment generator such as data environment generator 105 (FIG. 1). As discussed above, a data environment generator prepares an environment of data and/or data streams for processing by a BPU. The illustrated embodiment of data environment generator 105 includes a search engine 205, a data selection manager 210, a data preprocessor 215, and a data framework generator 220.

Search engine 205 is configured to receive manually inputted or automated queries and search for data. For example, semantic search of on-line (Internet) or off-line (local databases) can be performed. Search engine 205 can also return the results of the search.

Data selection manager 210 is configured to process search queries and select relevant search results based on the requirements of the application being developed with the neurosynaptic computer system. Data selection manager 210 can also be configured to retrieve data referenced in the search results.

Data preprocessor 215 is configured to preprocess data. For example, in some implementations, data preprocessor 215 can change the size and dimensions of data, create a hierarchy of resolution versions of the data, and create statistical variants of the data according the requirement of an application being developed with the neurosynaptic computer system. Example data augmentation techniques include statistical and mathematical filtering and machine learning operations. Example techniques for creating statistical variants of the data include introducing statistical noise, translations in the orientation, cropping, applying clip masks, and others. Example techniques for creating multiple resolution versions of the data include various mathematical methods for down sampling and dimensional reduction.

In some implementations, the preprocessing performed by data preprocessor 215 can include filtering operations. For example, the preprocessing can include simultaneous filtering in which multiple different versions of any particular input are presented simultaneously. For example, multiple filter functions can be applied to an image and presented together with the output of filters found by a machine learning model. This allows the other machine learning approaches to become the starting point for neurosynaptic computing.

As another example, the preprocessing can include cognitive filtering. For example, the background of an image can be processed through a machine learning model to obtain features related to the context of the image (i.e., a contextual filter). Another machine learning model can segment the image and obtain features of the objects that can be presented as perceptual filters. Additionally, the image can be preprocessed for the most salient information in an image to construct attention filters. Perceptual, Contextual and Attention filtered images can be processed simultaneously. The results of cognitive filtering can be processed by the neurosynaptic computer system simultaneously.

As another example, the preprocessing can include statistical filtering. For example, the pixel values of an image can be processed together with statistical measurements of the image (e.g., various distributions). Both the raw data and the results of statistical analysis of the raw data can be presented to and processed by the neurosynaptic computer system simultaneously.

Data framework generator 220 is configured to determine an organizational framework for the data, datasets, or data streams based on the computing requirements of the application being developed with the neurosynaptic computer system. Framework generator 220 can be configured to select from a variety of organizational frameworks such as a 1D vector, a 2D matrix, a 3D or higher dimensional matrix, and knowledge graph to create the space for the data to be processed.

A learning adapter such as a portion of learning adapter 130 can also govern learning and optimizations within and across the components of a data environment generator 105. For example, the portion learning adapter 130 can configured to set processes for optimizing and learning of the hyperparameters of each component of data environment generator 105, e.g., based on, e.g.,
supervisory, reward, or other signals from outside data environment generator 105 (e.g., from sensory encoder 110, from BPU 115, and/or from cognition encoder 120) or
supervisory, reward, or other signals from within data environment generator 105. For example, learning adapter 130 can include a feedforward learning adapter 135 and a feedback learning adapter. Feedforward learning adapter 135 can optimize hyperparameters based on, e.g., supervisory or other signals 225 from search engine 205, signals 230 from data selection manager 210, and/or signals 235 from data preprocessor 215 to improve the operations of one or more of data selection manager 210, data preprocessor 215, and data framework generator 220. Feedback learning adapter 135 can optimize hyperparameters based on, e.g., reward or other signals 245 from data framework generator 220, signals 245 from data preprocessor 215, and/or signals 250 from data selection manager 210 to improve the operations of one or more of search engine 205, data selection manager 210, and data preprocessor 215.

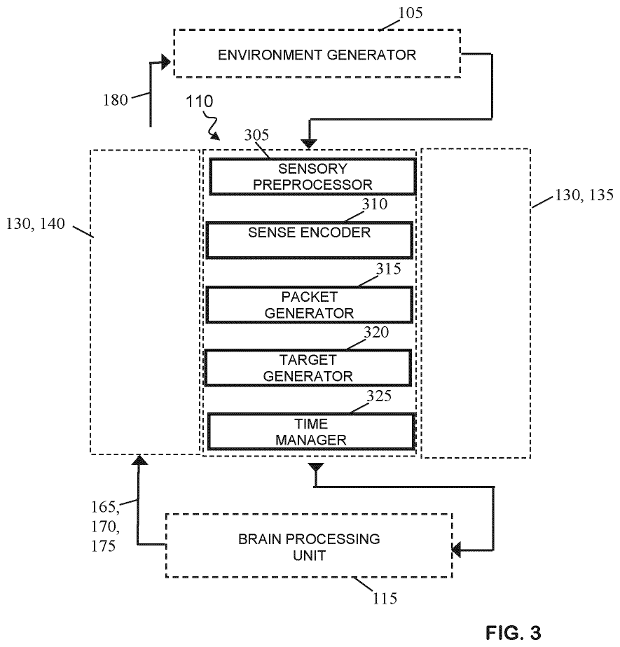

FIG. 3 is a schematic representation of a sensory encoder such as sensory encoder 110 (FIG. 1). As discussed above, a sensory encoder transforms a data file into a sensory code for input into a BPU. The illustrated embodiment of sensory encoder 110 includes a sensory preprocessor 305, a sense encoder 310, a packet generator 315, a target generator 320, and a time manager 325.

Sensory preprocessor 305 is configured to convert data files into a binary code format.

Sense encoder 310 is configured to read the binary code from sensory preprocessor 305 and apply one or a combination of encoding schemes to convert the bits and/or bytes into sensory input signals for processing by the BPU. Sense encoder 310 is configured to convert each byte value in the binary code by, for example:
converting each byte value to a different time point for the activation of neurons and/or synapses in the BPU (byte time encoding),
converting each byte value to statistical probabilities for the activation of neurons and/or synapses in the BPU (a byte probability encoding),
converting each byte value into proportional perturbations of different neuron and/or synapses in a BPU (byte amplitude encoding),
converting each byte value into a proportional perturbation of the number of neurons and/or synapses (byte population encoding scheme),
converting each byte value into frequencies of activation of neurons and/or synapses (byte frequency encoding) applying the series of activations either as a direct frequency or an amplitude and/or frequency modulation of a standardized oscillating wave input (byte frequency encoding),
converting each byte value to a proportional perturbation of the noise level of stochastic processes in the neurons and/or synapses (byte noise encoding),
converting each byte value to spontaneous synaptic events either as a set frequency or probability of spontaneous synaptic events (byte synapse spontaneous event encoding),
mapping the sequence of a bit in a byte to a sequential time point in a time series of events. The sequence of a bit in a byte can be mapped to a sequential time point in a time series of events in a variety of ways, including, e.g.:
   the ON bits marking a positive activation of neurons and/or synapses and the OFF bits producing no activation,
   the ON bits marking the positive activations of neurons (positive amplitudes applied) and/or synapses (increases in frequencies or probabilities of synaptic events) and the OFF bits marking the negative activations of the neurons (negative amplitudes applied) and/or synapses (decreases in frequency or probabilities of synaptic events), or
   the ON bits activating excitatory nodes in the BPU and OFF bits activating inhibitory nodes in the BPU, where the excitatory and inhibitory nodes are selected random or according to how they are connected to each other in the network.

Packet generator 315 is configured to separate the sensory signals into packets of the required size to match the processing capacity of the BPU.

Target generator 320 is configured to determine which components of the BPU will receive which aspects of the sensory input. For example, a pixel in an image can be mapped to a specific node or edge where the selection of modes and/or edges for each pixel/byte/bit location in the file is based on, e.g., the region of the BPU, the layer or cluster within a region, the specific XYZ voxel locations of the neurons and/or synapses within a region, layer, or cluster, the specific types of neurons and/or synapses, specific neurons and synapses, or a combination of these.

Time manager 325 is configured to determine the time interval between packets of data in a time series or sequence of packets.

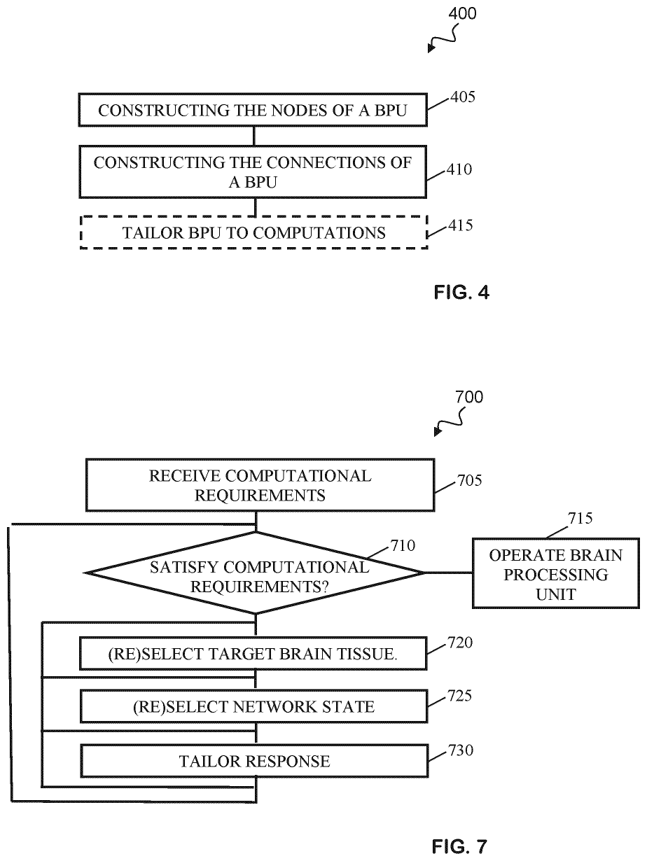

FIG. 4 is a flowchart of a process 400 for constructing a brain processing unit such as, e.g., BPU 115 (FIG. 1). Process 400 can be performed by one or more data processing devices that perform data processing activities. The activities of process 400 can be performed in accordance with the logic of a set of machine-readable instructions, a hardware assembly, or a combination of these and/or other instructions.

At 405, the device performing process 400 constructs the nodes of the brain processing unit. At 410, the device performing process 400 constructs the connections between the nodes of the brain processing unit. Optionally, at 415, the device performing process 400 tailors the brain processing unit to the computations to be performed in a given application.

In more detail, in an implementation of a neurosynaptic computer, the brain processing unit is a spiking recurrent neural network that is modelled after the anatomical and physiological architecture of brain tissue, i.e., part of or the whole brain of any animal species. The degree to which the brain processing unit mimics the brain's architecture can be selected in accordance with the complexity of the computations that are to be performed. As a general principle, any changes to structural and functional properties of the nodes of a network affects the number and diversity of unitary computations (classes, sub-classes and variants within) of the brain processing unit. Any changes to the structural and functional properties of connections affects the number and diversity of states of entanglement of the computations (classes, sub-classes and variants within). Any changes to structural properties determine the number and diversity of unitary computations and states of entanglement possible for a brain processing unit, while any changes to functional properties affects the number and diversity of unitary computations and entanglements realized during the simulation of the input. However, changes to functional properties of nodes or connections can also change the number and diversity of unitary computations and states of entanglements.

Further, the brain processing unit can optionally be tailored or “upgraded” to the computations to be performed in a given application. There are several ways of doing this, including, e.g., (re)selection of the target brain tissue that is mimicked, (re)selection of the state of that target brain tissue, and (re)selection of the response properties of the brain processing unit. Examples are discussed in further detail below.

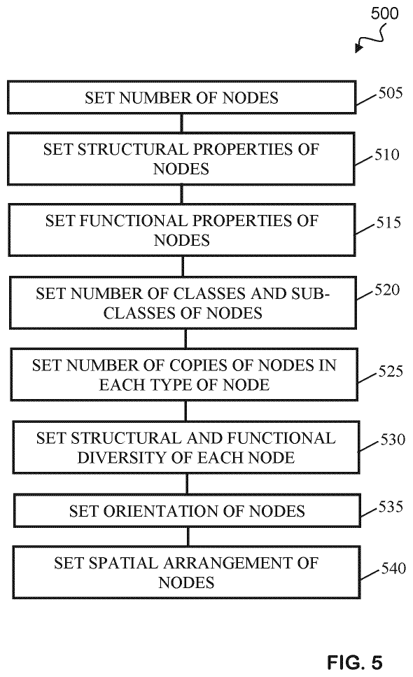

FIG. 5 is a flowchart of a process 500 for constructing the nodes of a brain processing unit such as, e.g., BPU 115 (FIG. 1). Process 500 can be performed by one or more data processing devices that arbitrarily accordance with the logic of a set of machine-readable instructions, a hardware assembly, or a combination of these and/or other instructions. Process 500 can be performed, e.g., at 405 in process 400 (FIG. 4).

At 505, the device performing process 500 sets the number of nodes. The total number of nodes to be used in the brain processing unit can in some implementations mimic the total number of neurons of a target brain tissue. Further, the number of nodes can determine the upper bound of the number of classes and sub-classes of unitary computation the brain processing unit can perform at any moment in time.

At 510, the device performing process 500 sets structural properties of the nodes. The structural properties of the nodes determine the temporal and spatial integration of the node's computation a function of time as the node combines inputs. This determines the class of unitary computations performed by the node. The structural properties of nodes also include the components of the node and the nature of their interactions. The structural properties can in some implementations mimic the effects of the morphological classes of neurons of the target brain tissue. For example, a branch-like morphology is a determinant of the transfer function applied for information received from other nodes by setting the amplitudes and shapes of the signal within the node when receiving input from other nodes in the network and in accordance with the location of a receiving synapse in the branching morphology.

At 515, the device performing process 500 sets functional properties of the nodes. The functional properties of the nodes determine the activation, integration, and response functions as a function of time and therefore determine the unitary computations possible with the node. The functional properties of nodes used in the construction of a brain processing unit can in some implementations mimic the types of physiological behaviors of different classes of neurons (i.e. their subthreshold and suprathreshold spiking behavior) of the target brain tissue.

At 520, the device performing process 500 sets the number of classes and sub-classes of nodes. The structural-functional diversity determines the number of classes and sub-classes of unitary computations. The number of combinations of structural-functional types of properties used in the construction of a brain processing unit can in some implementations mimic the number of morphological-physiological combinations of neurons of the target brain tissue.

At 525, the device performing process 500 sets the number of copies of nodes in each type (class and sub-class) of node. The number of nodes of a given type determines the number of copies of the same class and the number of nodes that perform the same type of unitary computation. The number of nodes with the same structural and functional properties in a brain processing unit can in some implementations mimic the number of neurons forming each morphological-physiological type in the target brain tissue.

At 530, the device performing process 500 sets the structural and functional diversity of each node. The structural and functional diversity of a node determines the quasi-continuum of variations of unitary computations within each class and sub-class of node. The degree to which each node of a given type diverges from identical copies can in some implementations mimic the morphological-physiological diversity of neurons within a given type of neuron in the target brain tissue.

At 535, the device performing process 500 sets the orientations of the nodes. The orientation of each node can include the spatial arrangement of the node components, Node orientation determines the potential classes of entangled states of a brain processing unit. The orientation of each node used in the construction of a brain processing unit can in some implementations mimic the orientation of the branching structure of the morphological types of neurons in the target brain tissue. The morphological orientation is a determinant of which neurons can send and receive information from any one neuron to any other neuron and hence determines connectivity in the network.

At 540, the device performing process 500 sets the spatial arrangement of nodes. The spatial arrangement determines which neurons can send and receive information from any one neuron to any other neuron and is therefore a determinant of the connectivity in the network and hence the diversity of entangled states of a brain processing unit. The spatial arrangement of nodes can include layering and/or clustering of different types of nodes. The spatial arrangement of each type of node used to construct a brain processing unit can in some implementations mimic the spatial arrangement of each morphological-physiological type of neuron of the target brain tissue.

The spatial arrangement also allows subregions of the brain processing unit to be addressed with readings from other subregions, defining an input-output addressing system amongst the different regions. The addressing system can, for example, be used to input data into one sub-region and sample in another sub-region. For example, multiple types of inputs, such as contextual (memory) data can be input to one sub-region, direct input (perception) can be addressed to another sub-region, and input that the brain processing unit should give more attention to (attention) can be addressed to a different sub-region. This allows brain processing sub-units that are each tailored for different cognitive processes to be networked. In some implementations, this can mimic the way neuronal circuits and brain regions of the brain are connected together.

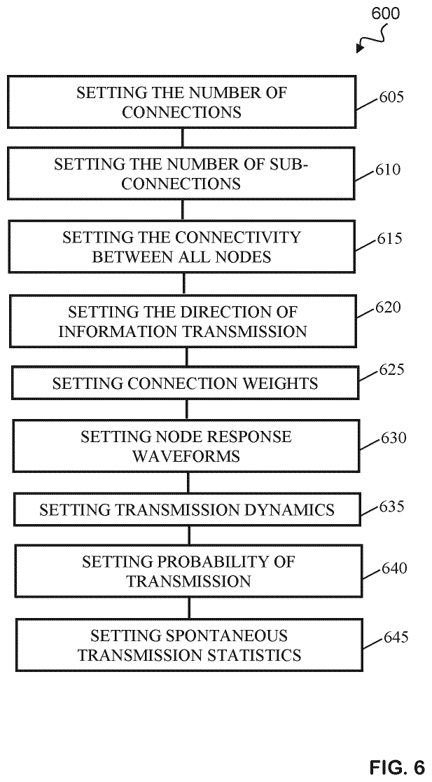

FIG. 6 is a flowchart of a process 600 for constructing the connections of the nodes of a brain processing unit such as, e.g., BPU 115 (FIG. 1). Process 600 can be performed by one or more data processing devices that arbitrarily accordance with the logic of a set of machine-readable instructions, a hardware assembly, or a combination of these and/or other instructions. Process 600 can be performed, e.g., at 410 in process 400 (FIG. 4).

At 605, the device performing process 600 sets the number of connections. The number of connections determines the number of possible classes of entangled states of a brain processing unit. The total number of connections between nodes can in some implementations mimic the total number of synapses of the target brain tissue.

At 610, the device performing process 600 sets the number of sub-connections. The number of sub-connections forming connections determines the variations within each class of entangled states. The number of parallel sub-connections that form a single connection between different types of nodes can in some implementations mimic the number of synapses used to form single connections between different types of neurons.

At 615, the device performing process 600 sets the connectivity between all nodes. The connectivity between nodes determines the structural topology of the graph of the nodes. The structural topology sets the number and diversity of entangled states that a brain processing unit can generate. The connectivity between different node types and between individual nodes can in some implementations mimic the specific synaptic connectivity between the types of neurons and individual neurons of a target brain tissue or at least key properties of the connectivity.

At 620, the device performing process 600 sets the direction of information transmission. The directionality of connections determines the direction of information flow and hence the functional topology during the processing of an input. The functional topology determines the number and diversity neurotopological structures, hence the number and diversity of active topological elements, and consequently the number and diversity of unitary computations and the number and diversity of their entangled states. The directionality of flow of information at connections can in some implementations mimic the directionality of synaptic transmission by synaptic connections of the target brain tissue.

At 625, the device performing process 600 sets connection weights. The weight settings for each type of synaptic connection (between any two types of nodes) determines the input variables for unitary computations and the number and diversity neurotopological structures activated during the input, and consequently the number and diversity of unitary computations active during the input and the number and diversity of their entangled states. The distribution of weight settings used to determine the amplitudes of responses to spikes in nodes mediated by different types of connections between nodes can in some implementations mimic the weight distributions of synaptic connections between different types of neurons in the target brain tissue.

In some implementations, the device performing process 600 adds a mechanism for changing the weights at individual connections in the brain processing units. Changing weights at connections allows the brain processing unit to learn generated classes of unitary computations and specific entangled states and hence learn the target output functions for the given input. The added mechanism for changing the weights at individual connections can in some implementations mimic mechanisms of synaptic plasticity of the target brain tissue.

In some implementations, the device performing process 600 adds a mechanism for transiently shifting or changing the overall distribution of weights of different types of connections to the brain processing unit that is constructed. Transient changes in weight distributions transiently changes the classes of unitary computations and classes of states of entanglement. Mechanisms for transiently shifting or changing the overall distribution of weights of different types of connections can in some implementations mimic mechanisms of neuromodulation of different types of synaptic connections by neurochemicals of the target brain tissue.

At 630, the device performing process 600 sets node response waveforms. The specific waveform of the response induced by a single spike in a sending node can in some implementations mimic the location-dependent shape of synaptic responses generated in a corresponding type of neuron with a given membrane resistance and capacitance in the target brain tissue.

In some implementations, the device performing process 600 adds a mechanism for changing the waveform of responses caused by individual connections can be added to the brain processing unit that is constructed. Mechanisms for changing the waveform of responses caused by individual connections can in some implementations mimic mechanisms of changing the functional properties of node (membrane resistance and/or capacitance and/or active mechanisms in the node) of target brain tissue.

In some implementations, the device performing process 600 adds a mechanism for transiently changing the distribution of waveforms of synaptic responses to the brain processing unit that is constructed. Mechanisms for transiently changing the distribution of waveforms of synaptic responses can in some implementations mimic mechanisms of neuromodulation of different types of neurons by neurochemicals of the target brain tissue.

At 635, the device performing process 600 sets transmission dynamics. The dynamically changing response amplitude of an individual connection during a sequence of spikes from a sending node can in some implementations mimic the dynamically changing synaptic amplitudes of synaptic connections of the target brain tissue.

In some implementations, the device performing process 600 sets different types of transmission dynamics. The types of dynamics at connections during spike sequences can in some implementations mimic the types of dynamic synaptic transmission at synaptic connections between different types of neurons of the target brain tissue.

In some implementations, the device performing process 600 adds a mechanism for changing the parameters of the function that determines the types of transmission dynamics. The mechanism for changing the parameters of the function that determines the types of transmission dynamics can in some implementations mimic mechanisms of synaptic plasticity of synapses of the target brain tissue.

In some implementations, the device performing process 600 adds a mechanism for transiently changing the distribution of each parameter of each type of transmission dynamic. The mechanism for transiently changing the distribution of each parameter of each type of transmission dynamic can in some implementations mimic mechanisms of neuromodulation of different types of synaptic connections by neurochemicals of the target brain tissue.

At 640, the device performing process 600 sets a probability of transmission. The probability of transmission can embody the probability of information flow at a connection and can determines the class of unitary computations, e.g., such as allowing stochastic and Bayesian computations in the brain processing unit. The probability that, given a spike in a sending node, a response is generated by the sub-connections forming any single connection can in some implementations mimic the probability of that neurotransmitter is released by a synapse in response to a spike from a sending neuron of a target brain tissue.

In some implementations, the device performing process 600 adds a mechanism for changing the probability of transmission at single, individual connections. Mechanisms for changing the probability of transmission at single connections mimic mechanisms of synaptic plasticity of synaptic connections of the target brain tissue.

In some implementations, the device performing process 600 adds a mechanism for changing the distribution of probabilities of different types of connections. Mechanisms for changing the distribution of probabilities of different types of connections can in some implementations mimic mechanisms of neuromodulation of different types of synaptic connections by neurochemicals of the target brain tissue.

At 645, the device performing process 600 sets spontaneous transmission statistics for the connections. Spontaneous transmission is the spontaneous (i.e., non-spike induced) flow of information across a connection. Spontaneous transmission can be implemented as an random process inherent to a connection in a brain processing unit and adds noise to the computation. Spontaneous transmission can pose an obstacle to information processing that must be overcome to validate the significance of the operations performed by the brain processing unit, hence enabling the brain processing unit to perform invariant information processing that is robust to noise in the input. Settings for spontaneous, non-spike induced flow of information at connections can in some implementations mimic the spontaneous release statistics of neurotransmitter release at synapses of the target brain tissue.

In some implementations, the device performing process 600 adds a mechanism for changing the spontaneous transmission statistics at individual connections. Mechanisms to change the spontaneous transmission statistics at individual connections mimic mechanism of synaptic plasticity of synaptic connections of the target brain tissue. Changing spontaneous transmission statistics at individual connections allows the connections of a brain processing unit to individually adjust the signal-to-noise of the information processed by the connection.

In some implementations, the device performing process 600 adds a mechanism for changing the distribution of spontaneous transmission statistics at each type of connection. Transient and differential changes of the distributions of spontaneous transmission at different types of connections allow the brain processing unit to dynamically adjust the signal to noise ratio of information processing by each type of connection of the brain processing unit. Mechanisms to change the distribution of spontaneous transmission statistics at each type of connection can in some implementations mimic mechanisms of neuromodulation of different types of synaptic connections by neurochemicals of the target brain tissue.

FIG. 7 is a schematic representation of a process 700 for upgrading a brain processing unit. As discussed above, the brain processing unit can be tailored or upgraded to the computations to be performed in a given application.

Process 700 can be performed by one or more data processing devices that arbitrarily accordance with the logic of a set of machine-readable instructions, a hardware assembly, or a combination of these and/or other instructions. Process 700 can be performed, e.g., in conjunction with process 400 (FIG. 4)—either immediately thereafter or after operation of a brain processing unit for some time.

At 705, the device performing process 700 receives a description of the computational requirements of a given application. The computational requirements of an application can be characterized in a number of ways including, e.g., the complexity of the computations that are to be performed, the speed at which the computations are to be performed, and the sensitivity of the computations to certain data. Further, in some cases, the computational requirements may vary over time. For example, even if an ongoing process has fairly stable computational requirements, those computational requirements may change at certain times or when certain events occur. In such cases, a brain processing unit can be transiently upgraded to meet demand and then returned after the demand has abated.

At 710, the device performing process 700 determines if the current condition of the brain processing unit satisfies the computational requirements. A mismatch can occur in either direction (i.e., the brain processing unit can have insufficient or excessive computational capabilities) along one or more characteristics of the computations (e.g., complexity, speed, or sensitivity).

In response to determining that the computational requirements are satisfied, the brain processing unit can be operated at the current condition at 715. In response to determining that the computational requirements are not satisfied, the device performing process 700 can tailor or upgrade the brain processing unit to the computations to be performed.

For example, in some implementations, the device performing process 700 can tailor or upgrade the brain processing unit by (re)selecting the target brain tissue that is mimicked at 720. For example, in some implementations, brain tissue of a different animal or at a different developmental stage can be (re)selected. The cognitive computing capability of a brain depends on the species and age of the brain. Neural networks that mimic brains of different animals and at different developmental stages can be selected to achieve the desired cognitive computing capabilities.

As another example, in some implementations, brain tissue of a different part of the brain can be (re)selected. The cognitive computing capability of different parts of the brain are specialized for different cognitive functions. Neural networks that mimic different parts of the brain can be selected to achieve the desired cognitive computing capabilities.

As yet another example, in some implementations, the amount of brain tissue of a part of the brain can be (re)selected. The cognitive computing capability of a brain region depends on how many sub-circuits are used and how they are interconnected. Neural networks that mimic progressively larger parts of the brain can be selected to achieve desired cognitive computing capabilities.

As another example, in some implementations, the device performing process 700 can tailor or upgrade the brain processing unit by (re)selecting the state of the brain processing unit at 725. Different aspects of the state of the neural network of the brain processing unit can be (re)selected. For example, the emergent properties that the network displays spontaneously can be (re)selected. As another example, the emergent properties that the network displays in response to input can be (re)selected. A (re)selection of the state of the neural network of the brain processing unit can have a variety of impacts on the operation of the brain processing unit. For example, the network may respond mildly or very strongly in response to input. As another example, the network may respond with a certain frequency of oscillations depending on the state. The range of computations that the network can perform can also be dependent on the state of the network.

For example, in some implementations, the device performing process 700 can (re)select the state of the brain processing unit by modulating parameters that determine the amplitude and dynamics of synaptic connections. The synaptic parameters that determine the amplitude and dynamics of synaptic connections between specific types of nodes of the network can be differentially changed to mimic the modulation of synapses in the brain by neuromodulators such as acetylcholine, noradrenaline, dopamine, histamine, serotonin, and many others. These controlling mechanisms allow states such as alertness, attention, reward, punishment, and other brain states to be mimicked. Each state causes the brain processing unit to generate computations with specific properties. Each set of properties allows for different classes of cognitive computing.

As another example, in some implementations, the device performing process 700 can (re)select the state of the brain processing unit by differentially altering the response activity of different types of neuron. This can modulate the state of the network and control the classes of cognitive computing.

As yet another example, in some implementations, the device performing process 700 can (re)select the state of the brain processing unit by tailoring the response of the brain processing unit at 730. The nodes and synapses of a brain processing unit respond to stimuli when processing information. A generic response may suffice for many tasks. However, specialized tasks may require special responses such as specific forms of oscillations or different extents to which all the nodes and synapses are activated.

The response properties of the brain processing unit can be optimized, e.g.:
on a population level such that the optimization function is the total response of all neurons during the input,
on a topological level such that the optimization function seeks to maximize the specific classes of computations that a cognition encoder (e.g., cognition encoder 120 (FIG. 1)) requires to construct the neural code,
to a specific task such that the optimization function is the performance of the cognitive algorithm that is produced by a cognition encoder using a feedback signal from an action generator (e.g., action generator 125 (FIG. 1)),
to information storage in memory such that the optimization function is to maximize the amount of information that the systems holds in memory about any previous inputs (e.g., either previous time points in a time series or previous data files), and/or
to prediction such that the optimization function is to maximize the response to correctly predicted subsequent inputs (e.g., subsequent inputs in a time series of inputs or subsequent data files).

After tailoring or upgrading the brain processing unit to the computations to be performed, the device performing process 700 can return to 710 and determine if the current condition of the brain processing unit satisfies the computational requirements. In response to determining that the computational requirements are satisfied, the brain processing unit can be operated at the current condition at 715. In response to determining that the computational requirements are not satisfied, the device performing process 700 can further tailor or upgrade the brain processing unit.

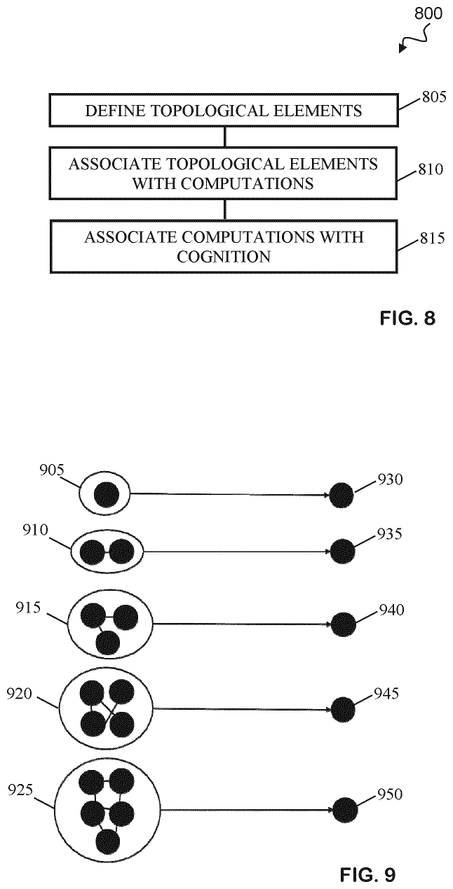

FIG. 8 is a flowchart of a process 800 for constructing a cognition encoder such as, e.g., cognition encoder 120 (FIG. 1). Process 800 can be performed by one or more data processing devices that perform data processing activities. The activities of process 800 can be performed in accordance with the logic of a set of machine-readable instructions, a hardware assembly, or a combination of these and/or other instructions.

As discussed above, a neurosynaptic computer system organizes decisions at different hierarchical levels to construct arbitrarily complex cognitive algorithms. A cognition encoder can identify and encode these decisions at different levels in a neural code.

In more detail, a brain processing unit subjects input to a diversity of arbitrarily complex computations that each become entangled through any one or all of the parameters of each computation. This results in a range of computations with multidimensional interdependencies. A cognitive encoder constructs cognitive processes by setting desired properties of the computations performed by the topological elements and finds a subset of entangled computations to form a hierarchical neural code that represents a target cognitive algorithm. The multi-dimensional range of computations is defined by the topological elements that perform the elementary, unitary, and higher-order computations—as well as by setting the criteria for evaluating these computations. Finding the subset of entangled computations that perform cognitive functions in the universe of computations is achieved by mimicking entanglement processes performed by the recurrent network of the brain processing unit. The subset of entangled computations is then formatted as a hierarchical neural code that can be used for data storage, transmission, and computing. Process 800 is a process for constructing such a cognition encoder.

At 805, the device performing process 800 defines topological elements of the cognition encoder. As used herein, topological elements are selected discrete components of a brain processing unit that perform computations. These computations can be precisely represented mathematically by a topological relationship between the elements. In somewhat reductive instances, a topological element is a single element, e.g., a single molecule or cell. The single molecule or cell can perform a computation that can be represented mathematically. For example, a molecule can be released at a particular location or a cell can depolarize. The release or depolarization can indicate completion of a computation and can be used to encode the state of decisions.

However, in general, topological elements are groups of components, e.g., a network of molecules, a selected sub-group of cells, a network of cells, and even groups of such groups. For example, multiple networks of cells that have a defined topological relationship to one another can form a topological element. Once again the computations performed by such groups can be represented mathematically by a topological relationship between the elements. For example, a pattern of a network of molecule can be released or a network of cells can depolarize in a pattern that comports with a topological pattern. The release or depolarization can indicate completion of a computation and can be used to encode the state of decisions.

FIG. 9 is a schematic representation of neurotopological elements that have been constructed from a node and from combinations of nodes in a neural network. In particular, in the simplest case, a single node 905 is defined as a neurotopological element 930. The output of node 905 (e.g., a depolarization event)—and hence the output of neurotopological element 930—is a unitary decision.

In other cases, groups 910, 915, 920, 925 of multiple nodes are defined as respective neurotopological elements 935, 940, 945.950. The nodes in each group 910, 915, 920, 925 can show activity (e.g., depolarization events) that comport with a topological pattern. The occurrence of such activity is a unitary decision and indicates the result of computations.

In some cases, the result of computation (i.e., the output of neurotopological elements 930, 935, 940, 945, 950) is a binary value indicating either that a decision has been reached or has not been reached. In other cases, the output can have an intermediate value indicating that a decision is incomplete. For example, the partial value can indicate that some portion of the activities that comport with a topological pattern have occurred, whereas others have not. The occurrence of only a portion of the activities can indicate that the computation represented by the neurotopological element is incomplete.

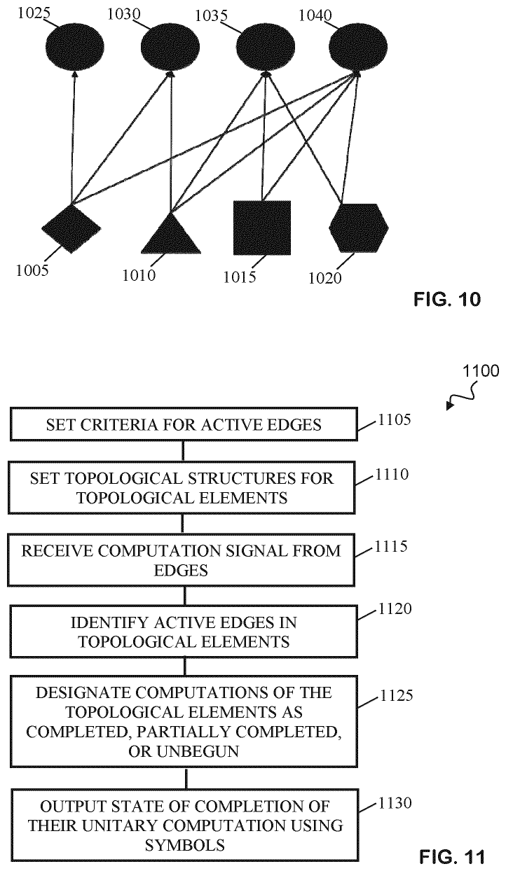

FIG. 10 is a schematic representation of neurotopological elements that have been constructed from combinations of different components of a neural network. In the schematic representation, component 1005 is a schematic representation of one or more molecules of a neural network. Component 1010 is a schematic representation of one or more synapses of a neural network. Component 1015 is a schematic representation of one or more nodes of a neural network. Component 1020 is a schematic representation of one or more nodal circuits of a neural network.

A neurotopological element 1025 has been defined to include only molecular component(s) 1005. In contrast, a neurotopological element 1030 has been defined to include both molecular component(s) 1005 and synaptic component(s) 1010. A neurotopological element 1035 has been defined to include synaptic component(s) 1010, nodal component(s) 1015, and nodal circuit component(s) 1020. A neurotopological element 1040 has been defined to include molecular component(s) 1005, synaptic component(s) 1010, nodal component(s) 1015, and nodal circuit component(s) 1020.

Regardless of how they are defined, each neurotopological element 1025, 1030, 1035, 1040 output a unitary decision that is determined by the hierarchically embedded decisions made by the component elements of the neurotopological element. The hierarchically embedded decisions of the component elements can be evidenced by, e.g., release into a location, inhibition or excitation at a synapse, activity in a neuron, or a pattern of activity in a circuit. The activity that evidences these decisions can comport with a topological pattern. The occurrence of such activity is a unitary decision and indicates the result of computations. As the complexity of the components in a neurotopological element increases, the complexity of the neurotopological element increases and the likelihood that the decision was reached by accident or inadvertently (e.g., due to spontaneous transmission) decreases. For example, a neurotopological element that includes a nodal circuit component 1020 indicates a more complex decision and computation that is less likely to be inadvertent than a neurotopological element that includes a single nodal component 1020.

As before, in some cases, the result of computation is a binary value indicating either that a decision has been reached or has not been reached. In other cases, the output can have an intermediate value indicating that a decision is incomplete.

Returning to 805 in process 800 (FIG. 8), in defining topological elements, the device performing process 800 can select components of the brain processing unit for the topological elements. As an example of an implementation of a neurosynaptic computer, the brain processing unit is associated with a graph with the same number of nodes and edges as neurons and synaptic connections as in the brain processing unit. An edge in the graph is said to be a structural edge if a synaptic connection exists between two nodes. The direction of an edge is given by the direction of synaptic transmission from one node to the next. An edge is said to be an active edge if a sending node transmits information to a receiving node, according to given criteria. As explained in more detail below, the criteria can be tailored to identify an intermediate range of active edges for a given application. The subset of active edges in the network at any moment in time are considered together to form a time series of functional graphs. Any individual edge or any combination of more than one edge can constitute a single topological element. The topological structure of a topological element is described by the graph relationship of the edges. Topological elements are said to be active when their constituent edges are active according to the criteria for identifying an active edge. As explained in more detail below, topological structure of a topological element can be tailored to the complexity of the computations for a given application.

At 810, the device performing process 800 associates these topological units with computations. As described above, the types and resolution of elementary computations depends on how active edges and topological structures are defined. The topological units defined by these topological structures can be associated with different computations by characterizing the activity of the topological structures in a symbolic representation, e.g., a series of 0's, 1's, and intermediate values.

FIG. 11 is a flowchart of a process 1100 for defining topological elements (e.g., at 805 in FIG. 8) and associating topological units with computations (e.g., at 810 in FIG. 8). Process 1100 can be performed by one or more data processing devices that perform data processing activities. The activities of process 1100 can be performed in accordance with the logic of a set of machine-readable instructions, a hardware assembly, or a combination of these and/or other instructions.

At 1105, the device performing process 1100 sets criteria for identifying an active edge. An active edge reflects the completion of an arbitrarily complex elementary computation and the communication of that result to a specific target node.

Since active edges are generated by the transmitting node in response to multiple inputs from other nodes in the network—and this input from the other nodes is in turn a response to inputs from yet other nodes (and so on)—every elementary computation performed by every active edge is in principle a function of the activity throughout the entire network.

As discussed above, an edge is said to be active if the transmission of information from a sending node to a receiving node satisfies one or more criteria. The criteria can be tailored so that an intermediate number of active edges are identified. In more detail, if criteria for identifying an active edge are too stringent, then no edges will be identified as active. In contrast, if criteria for identifying an active edge are too loose, then too many edges will be identified as active. The criteria can thus be tailored to other parameters of the brain processing unit and the operations to be performed. Indeed, in some implementations, the setting of criteria is an interactive process. For example, the criteria can be adjusted over time in response to feedback indicating that too few or too many edges are identified as active.

At 1110, the device performing process 1100 sets topological structures for the topological elements. When all edges forming a single topological element are active, the unitary computation performed by that topological element is complete. However, if only a fraction of the edges that make up the topological element is active, the unitary computation is partially complete. If none of the edges of a topological element are active, the unitary computation has not begun. The specific combination of edges in the set topological elements that can become active in response to an input therefore defines the range of completed, partially completed, and unbegun unitary computations. A unitary computation is thus a function of the elementary computations performed by the edges and, as discussed above, the resolution of unitary computations is controlled by tailoring the criteria for defining an edge as active.

A variety of different topological structures can be defined. The types of unitary computations can be controlled by selecting the topological structure(s) that constitute a topological element. For example, a topological element that is defined as a single active edge yields a minimally complex unitary computation. In contrast, defining the topological element as a topological structure composed of a nodal network with multiple active edges yields a more complex unitary computation. Defining the topological element as a topological structure composed of multiple nodal networks yields a yet more complex unitary computation.

Further, the diversity of the defined topological structures controls the diversity of unitary computations that can be read from the brain processing unit. For example, if all of the topological elements are defined as single edges, the possible unitary computations tend to uniformly minimal complexity. On the other hand, if the topological elements are defined as mixtures of different topological structures, the range of unitary computations becomes more diverse and contains heterogeneous types of unitary computations.

At 1115, the device performing process 1100 receives signals from the edges in a brain processing unit. At 1120, the device performing process 1100 identifies topological elements in which none, some, or all of the edges are active. At 1125, the device performing process 1100 designates the computations of the topological elements as completed, partially completed, or unbegun. At 1130, the device performing process 1100 outputs a symbolic description of the state of completion of the unitary computations.

In some implementations, the device performing process 1100 can output a list of topological elements and associated descriptions of the state of completion of their respective unitary computation. For example, a completed unitary computation can be mapped to a “1”, a partially completed unitary computation can be mapped to values between “1” and “0” depending on the fraction of edges active forming a topological element, and unitary computations that have not been performed can be mapped to a “0.” According to this example mapping convention, input to the brain processing generates a universe of unitary computations and selected of these computations are represented by values ranging from “0” to “1.”

Other symbols can be mapped to the state of completion of computations. For example, a different symbolic scheme can be used to separately track the completion of each type of unitary computation, defined by the specific combination of edges used to define a topological element. In any case, the association of topological units with computations allows a neurosynaptic computer can track the states of completion of unitary computations performed by a set of topological elements on a set of input data.

At 815, the device performing process 800 associates these computations with cognition. Different cognitive algorithms arise from different combinations of decisions and the entangling of these decisions. Thus, the computations associated with different topological units can be used to assemble and arbitrarily complex hierarchy of different combinations of decisions. Further, the results of those decisions can be output as a symbolic computer language that includes a set of decisions.

The unitary decisions in a set of unitary decisions that forms a unitary cognitive operation are interdependent. Each unitary decision is a function of a specific combination of active edges. The active edges are each a unique function of the activity the entire network of the brain processing unit. Since the elementary computations performed by active edges and unitary computations performed by topological elements are of arbitrarily complexity, there exists an arbitrarily large number of dependencies between the unitary decisions that form a unitary cognitive operation. The specific dependencies that emerge during the processing of an input define the specific state of entanglement of unitary decisions. As discussed further below, multiple combinations or hierarchical levels of decisions are also possible. The dependencies that emerge during the processing of an input between the decisions on one level have a state of entanglement that defines a decision on a higher level.

It is not necessary that the precise nature of the elementary computations performed by active edges nor the unitary computations performed by topological elements be known. Rather, it is sufficient that the elementary computations and the states of completion of unitary computations of the topological elements be tracked. A computation performed on an input is therefore a specific combination of states of completion of unitary computations. Further, states of completion of unitary computations can be mapped to states of completion of cognitive computations. The unitary computations of topological elements can be associated with cognitive computations using the following design logic.

An active edge—which defines an elementary computation—also defines an elementary decision reached by the network in the brain processing unit. An elementary decision is considered to be a fundamental unit of a decision. A specific combination of active edges of a topological element that defines a unitary computation also defines a unitary decision. A unitary decision is thus composed of a set of elementary decisions.

The state of an elementary decision is a binary state because the edge is either active or not. However, the state of a unitary decision associated with a neurotopological element that includes multiple components ranges from 0 to 1 because it can depend on the fraction and combination of elementary binary states (i.e., a set of “0's” and “1 's”) of the components of the neurotopological element.

A unit of cognition or a unitary cognitive operation is defined as a set of unitary decisions, i.e., a set of unitary computations associated with a set of topological elements. The type of unitary cognitive operation is defined by the number and the combination of its constituent unitary decisions. For example, in cases wherein the unitary decisions are captured in a list of topological elements and associated descriptions of the state of completion of their respective unitary computation, a unitary cognitive operation can be signaled by a set of values ranging from 0 to 1 of the constituent unitary decisions.

In some cases, unitary cognitive operations can be quantized and characterized as either complete or incomplete. In particular, incomplete unitary computations (i.e., the unitary computations otherwise characterized by values between 0 and 1) can be set to “0” (e.g., treated as unbegun). Only cognitive operations that exclusively include completed unitary computations (i.e., exclusively “1's”) can be considered completed.

Further, additional combinations or hierarchical levels of decisions are also possible. For example, a set of unitary cognitive operations can define a cognitive function and a set of cognitive functions can define the system cognition. In effect, the relationships engineered between the unitary cognitive operations defines the type of cognitive function and the relationships engineered between the cognitive functions defines the type of cognitive computing. Additional combinations or hierarchical levels are also possible.

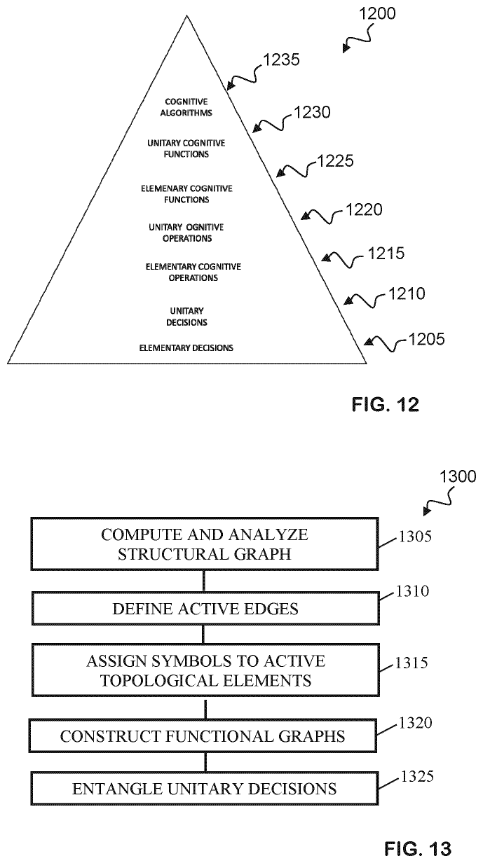

FIG. 12 is schematic representation of a hierarchical organization 1200 of decisions within cognition. It is emphasized that hierarchical organization 1200 is one example. More or fewer level are possible. Further, computations can be entangled across levels. Nevertheless, hierarchical organization 1200 is an illustrative example of decision levels within cognition.

Hierarchical organization 1200 includes elementary decisions 1205, unitary decisions 1210, elementary cognitive operations 1215, unitary cognitive operations 1220, elementary cognitive functions 1225, unitary cognitive functions 1230, and cognitive algorithms 1235.

As discussed above, a cognition encoder can identify and encode decisions at different levels in a neural code. The design logic of a neural code creates dependencies between the elementary decisions 1205 (made, e.g., by active edges) to form unitary decisions 1210 (made by active topological elements). The dependencies between the elementary decisions 1205 can be referred to as the state of entanglement that defines a unitary decision 1210. Other states of entanglement define the dependencies between the unitary decisions 1210. These states of entanglement form elementary cognitive operations 1215. Other states of entanglement define the dependencies between elementary cognitive operations 1215. These states of entanglement form unitary cognitive operations 1220. Still other states of entanglement can define the dependencies between unitary cognitive operations 1220. These states of entanglement form elementary cognitive functions 1225. Still other states of entanglement can define the dependencies between elementary cognitive functions 1225. These states of entanglement form unitary cognitive functions 1230. Still other states of entanglement can define the dependencies between unitary cognitive functions 1230. These states of entanglement form a cognitive algorithm 1235. As one moves higher up the hierarchy, the complexity of the decisions that are reached increases.

Thus, in neurosynaptic computing, entanglement creates dependencies at each level, i.e., direct dependencies to the immediately lower level of processing and indirect dependencies to all other lower levels. For example, a unitary cognitive function 1230 is formed by direct dependencies upon elementary cognitive functions 1225 and indirect dependencies upon unitary cognitive operations 1220, elementary cognitive operations 1215, unitary decisions 1210, and at the lowest level, between elementary decisions 1205 made by active edges.

In the case where unitary decisions 1210 are quantized such that a “1” signals a completed decision and a “0” signals a partial and/or absent decision, a single set of “O's” and “l's” can represent a complete cognitive algorithm 1235. Such a single set of “O's” and “l's” forms a neural code symbolic language that signals the states of completion and entanglements of computations within and across multiple levels.

FIG. 13 is a flowchart of a process 1300 for constructing a neural code. Process 1300 can be performed by one or more data processing devices that perform data processing activities. The activities of process 1300 can be performed in accordance with the logic of a set of machine-readable instructions, a hardware assembly, or a combination of these and/or other instructions.

At 1305, the device performing process 1300 computes and analyzes a structural graph that represents the structure of the brain processing unit. For example, an undirected graph can be constructed by assigning a bidirectional edge between any two interconnected nodes in the brain processing unit. A directed graph can be constructed by taking the direction of the edge as the direction of transmission between any two nodes. In the absence of input, all edges in the brain processing unit are considered and the graph is said to be a structural graph. The structural graph can be analyzed to compute all directed simplices that are present in the structural directed graph, as well as the simplicial complex of the structural directed graph. If needed, other topological structures, topological metrics, and general graph metrics can be computed. Examples of topological structures include maximal simplices, cycles, cubes, etc. Examples of topological metrics include the Euler characteristic. Examples of general graph metrics include in- and out-degrees, clustering, hubs, communities, and the like.

At 1310, the device performing process 1300 defines active edges. As discussed above, the specific criteria used to define an active edge sets the type and precision of the computations that form elementary decisions. This in turn sets the types of computations contained in the computations from which the neural codes are constructed.

One class of criteria that can be used to define an active edge are causality criteria. One example of a causality criteria requires that—for an edge to be considered active—a spike be generated by a node, the signal transmitted to a receiving node, and a response be successfully generated in the receiving node. The response generated in the receiving node can be, e.g., a sub-threshold response that does not generate a spike and/or the presence of a supra-threshold response that does generate a spike. Such causality criteria can have additional requirements. For example, a time window within which the response must occur can be set. Such a time window controls the complexity of computation included in the elementary decision signaled by an active edge. If the time window for causality is decreased, the computations performed by the receiving node become restricted to a shorter time for the receiving node to perform its computation. Conversely, a longer time window allows the node to receive and process more inputs from other sending nodes and more time to perform the computation on the input. The computations—and decisions reached—with a longer time window therefore tend to be more complex the longer the time window becomes.

Another class of criteria that can be used to define an active edge are coincidence criteria. One example of a coincidence criterion requires that—for an edge to be considered active—both the sending and receiving nodes must spike within a given time window without limiting which node spikes first. The timing and the duration of the time window for recognizing a coincident receiving node spike sets the strictness of the coincidence criterion. A short time window that occurs immediately after the sending node's spike represents a relatively strict condition for considering spikes to be coincident. In effect, an active edge that satisfies a coincidence criterion indicates that that network is oscillating within a frequency band given by the duration of the time window.

Another class of criteria that can be used to define an active edge are oscillation criteria. One example of an oscillation criterion requires that—for an edge to be considered active—multiple coincidence criteria be satisfied by different edges or different types of edges. This joint behavior amongst the active edges indicates that that network is oscillating with a frequency band defined by the time windows.

In some implementations, different causality, coincidence, and oscillation criteria can be applied to different edges and/or different classes and types of edges.

At 1315, the device performing process 1300 assigns symbols to represent the active topological elements. For example, a “1” can be assigned to a topological element if all edges of the topological element are active, a “0” can be assigned if none of the edges of are active, and a fractional number between 1 and 0 can be assigned to indicate the fraction of edges active. Alternatively, for partially active topological elements, a number can be assigned that indicates the specific combination of edges active. For example, a sequence of active/non-active edges (e.g. “01101011”) could be assigned a value using the binary system).

In some implementations, the representation of active topological elements can be quantized. For example, a “1” can be assigned to a topological element only if all components in the topological element are active. A “0” is assigned if none or only some of the components are active.

At 1320, the device performing process 1300 constructs functional graphs of the brain processing unit. For example, functional graphs can be constructed by dividing, into time bins, the operations of the brain processing unit in response to an input. Using the structural graph, only the nodes with active edges in each time bin can be connected, thereby creating a time series of functional graphs. For each such functional graph, the same topological analysis that was performed at 1305 on the structural graph can be performed. In some implementations, topological elements can be unified across time. In some implementations, global graph metrics or meta information that may be useful to guide computations using the above schema can be associated with the functional graphs.

In any case, using such functional graphs, a collection of symbols (e.g., “1's” and “0's”—with or without intermediate real numbers to indicate partially active neurotopological structures) that represent the active and inactive neurotopological structures can be output. In some implementations, the output can also include global metrics of the graph's topology and meta data about the way the functional graph was constructed.

At 1325, the device performing process 1300 can entangle unitary decisions of the brain processing unit. In general, a brain processing unit will be so large that it reaches a vast number of decisions. Individual consideration of those decisions will generally prove intractable. Entanglement of the decisions selects a subset of the decisions that are most involved in the processing of the input data.

In general, the device performing process 1300 will select a subset of the decisions for entanglement. The selected subset will include the decisions that are most relevant to the processing of a particular input dataset and the cognition that is to be achieved. Relevant decisions can be selected according to their activation patterns during the input of each file in a dataset. For example, the number of times that a topological element is active during the processing of a single input and across a dataset of inputs is an indication of the relevance of that topological element. A histogram of the frequencies of activation of different decisions can be constructed and decisions can be selected based on these frequencies. For example, decisions that are active for only a small fraction of the dataset may be used in the construction a cognitive algorithm for anomaly detection.

As another example, decisions can be selected based on a hierarchy or binning of the frequencies of activation. For example, decisions that become active in a bin of frequencies across the dataset (e.g., the 10% of unitary decisions are active for 95% of the inputs in a dataset of inputs, 20% of unitary decisions are active for 70% % of the inputs in a dataset of inputs, 50% for 50% of the inputs in a dataset of inputs) can be selected.

As another example, decisions can be selected based on global graph metrics. For example, if the selection is driven by an entropy optimization target, then only decisions that are 50% active across inputs are selected. As another example, decisions that are active at a specific moment that a specific pattern, such as a pattern of Betti numbers, can be detected and selected.

After any selection of the subset of the decisions for entanglement, the device performing process 1300 can entangle the decisions. In particular, further subsets of the selected decisions can be selected at each level in the hierarchy.

For example, in some implementations, the entanglement can decompose a cognitive algorithm into a hierarchy of functions and operations from the highest level to the lowest level. Each function and operation can be further decomposed into a hierarchy of sub-functions and sub-operations. Regardless of the details of the particular levels, decomposition of unitary decisions begins with the highest level of the hierarchy and works down to the lowest level of the hierarchy.

To decompose a cognitive algorithm, the device performing process 1300 can select highest target level in the hierarchy of decisions. For example, when the hierarchy is organized as shown in FIG. 12, the completed decisions of a cognitive algorithm (e.g., 1235, FIG. 12) can be selected. Each unitary decision of the next level down (e.g., each cognitive function 1230 in FIG. 12) is evaluated separately as to its information content about this decision in the highest target level in the hierarchy. A list of decisions can be constructed and sorted from highest information content to lowest information content. Other sorted lists can be constructed for other decisions in the highest target level.

The device performing process 1300 can then add unitary decisions decision of the next level down to the further subset by selecting unitary decisions from the list(s) and testing their collective performance on the decisions in the highest target level in the hierarchy. No further unitary decisions need be added to the subset when the performance increase per unitary decision of the next level down decreases to a low level (i.e., when the change in the performance per additional unitary decision decreases).

The unitary decisions of the next level down that have been found for this first highest target level in the hierarchy of decisions can then be provided as an input to constrain further selection of decisions in the next level down and construct a second target level of the hierarchy. After evaluation as to information content about this second target level, additional unitary decisions from a second target level can be selected. Thus, the subsets of the unitary decisions found for the first and the second target level of the hierarchy are used as the initial subset that constrains the selection of a further subset of the unitary decisions for a third level of the hierarchy. This continues until unitary decisions have been selected for all levels of the hierarchy of decisions.

In the context of the hierarchy of FIG. 12, the process of entangling unitary decisions can be repeated to entangle elementary cognitive functions 1225, unitary cognitive operations 1220, and elementary cognitive operations 1215, and unitary decision 1210. In the case where unitary decisions are binary, the subset of unitary decisions at each level of the hierarchy is a set of bits that grows in number to form the cognitive algorithm. The subset of decisions is referred to as the neural code.

In some implementations, a binary decision on the sequence of the subset can be made at each level to yield a smaller final subset of bits that encode the cognitive algorithm.

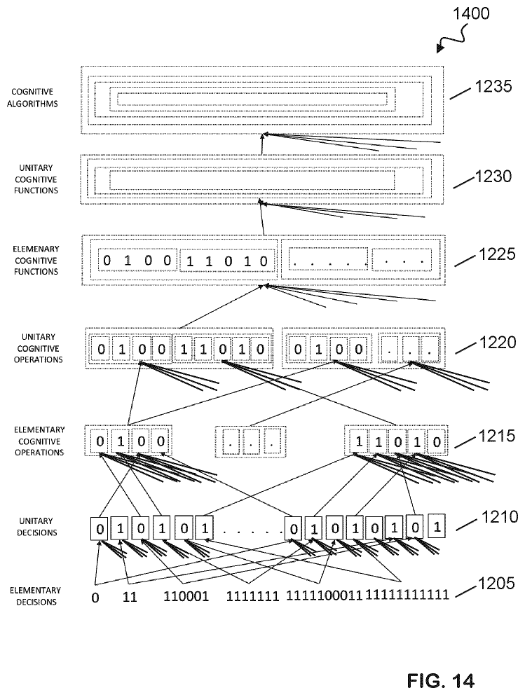

FIG. 14 is a schematic representation of the process for constructing hierarchical neural codes in the context of hierarchical organization 1200 shown in FIG. 12. A cognitive algorithm 1235 is selected as an initial highest target level. Unitary decisions at the level of unitary cognitive functions 1230 are selected based on their information content relative to the selected cognitive algorithm 1235. These unitary decisions at the level of unitary cognitive functions 1230 then form the target level, and unitary decisions at the level of elementary cognitive functions 1225 are selected based on their information content relative to the unitary decisions at the level of unitary cognitive functions 1230. This process continues until unitary decisions at the level of unitary decisions 1210 are selected.

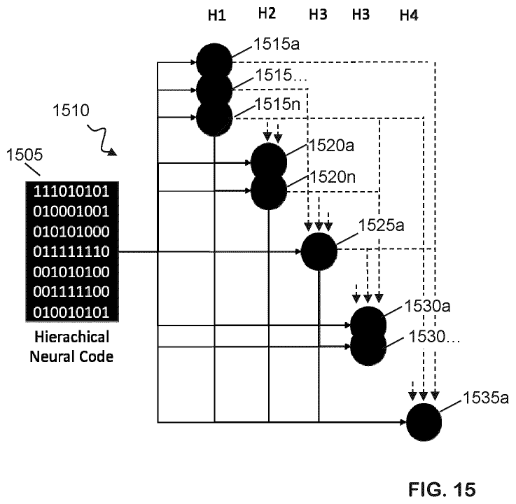

FIG. 15 is an example of process 1500 for decoding neural codes into their target outputs. Process 1500 can be performed by one or more data processing devices that perform data processing activities. The activities of process 1500 can be performed in accordance with the logic of a set of machine-readable instructions, a hardware assembly, or a combination of these and/or other instructions. For example, process 1500 can be performed by an action generator as action generator 125 (FIG. 1) to read and translate neural codes so that the cognitive functions encoded by the neural codes can be performed.

The action generator or other device that performs process 1500 is constructed to reverse the entanglement algorithm used to construct the hierarchical neural code and unentangle the hierarchy of decisions made by the brain processing unit. Each step in the unentanglement can be performed by any number of machine learning models or, in some cases, analytical formulations.

As shown, a neural code 1505 is received and input at 1510 into machine learning models 1515, 1520, 1525, 1530, 1535 that have each been trained to process the symbols of a relevant hierarchical level H1, H2, H3, H4 of the neural code. In the context of the hierarchical organization 1200 (FIG. 12), each of the machine learning models 1515, 1520, 1525, 1530, 1535 can be trained to process a respective of unitary decisions 1210, elementary cognitive operations 1215, unitary cognitive operations 1220, elementary cognitive functions 1225, unitary cognitive functions 1230, or the cognitive algorithm 1235. In some implementations, outputs from machine learning models at one hierarchical level (e.g., a lower level) can provide input to machine learning models at another hierarchical level (e.g., a higher level). Such input is represented schematically by the dashed lines interconnecting 1515, 1520, 1525, 1530, 1535.

In the illustrated implementation, neural code 1505 is shown as a collection of binary “1's” and “0's” that each represent whether a neurotopological structure is active and inactive. In other implementations, symbols or real numbers can be used.

Also, rather than a collection of machine learning models, a network of brain processing units can be used to decode neural codes into their target outputs.

In still other implementations, the hierarchical elements of the neural code can be mapped to a graph and graph signal processing approaches can be applied to decode the neural codes into their target outputs. Examples of such a graph signal processing approaches include graph convolutional neural networks. For example, unentanglement can be implemented as a graph where the nodes are machine learning models and the edges are the inputs received from other machine learning models.

The decoding provided by the action generator or other device that performs process 1500 can be lossless reconstruction of the original input data or a lossy reconstruction of a desired level of compression. The decoding can also provide various degrees of encryption, where the security level can be quantified by the probability of collisions in the output. Such an action generator or other device can also be designed to perform arbitrarily complex mathematical operations on the input data and provide a range of cognitive outputs for artificial intelligence applications.

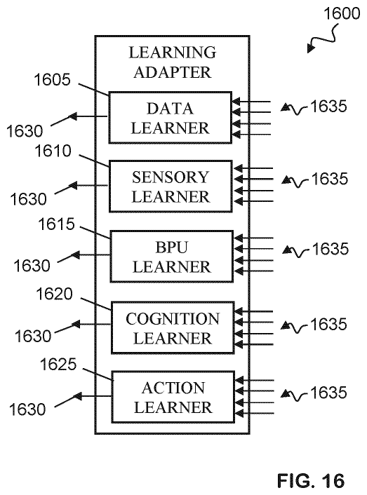

FIG. 16 is a schematic representation of a learning adapter 1600 such as learning adapter 130 (FIG. 1). As discussed above, a learning adapter generator is configured to optimize the hyperparameters of each of the components of a neurosynaptic computer. A learning adaptor receives hyperparameters from each of the components, optimizes the hyperparameters using a component-specific learning algorithm, and returns the hyperparameters to the component.

The illustrated embodiment of learning adapter 1600 includes a data learner 1605, a sensory learner 1610, a brain processing unit learner 1615, a cognition learner 1620, and an action learner 1625. Data learner 1605 is configured to optimize the search, preprocessing and organization of data by an environment generator before the data is sent to a sensory encoder. Sensory learner 1610 is configured to teach the sensory encoder to change the encoding of data to suit a computational task and to weaken some input channels and strengthen others. Brain processing unit learner 1615 is configured to allows a brain processing unit to learn to perform a computational task by guiding synapses to respond optimally to the input. Brain processing unit learner 1615 can also internally calibrate synapses and neuronal settings of the brain processing unit to improve the brain processing unit's prediction of future inputs. For example, brain processing unit learner 1615 can construct a range of desired computations that are to be performed by the brain processing unit. Cognition learner 1620 is configured to allow the brain processing unit to learn to perform the computational task by adapting the algorithms that provide the most relevant set computations/decisions required for the cognitive algorithm. Action learner 1625 is configured to allow the action generator to search automatically for new graph configurations for entangling the computations/decisions for the cognitive algorithm. A central design property of each of data learner 1605, sensory learner 1610, brain processing unit learner 1615, cognition learner 1620, and action learner 1625 is the ability to generate predictions of future outcomes.

Each of data learner 1605, sensory learner 1610, brain processing unit learner 1615, cognition learner 1620, and action learner 1625 outputs a respective signal 1630 for optimizing hyperparameters of the relevant component of the neurosynaptic computer. Each of data learner 1605, sensory learner 1610, brain processing unit learner 1615, cognition learner 1620, and action learner 1625 receives as input hyperparameters 1635 from the other components for optimizing the hyperparameters of the relevant component.

In operation, learning adaptor 1600 can be given a variety of target functions such as, e.g., minimizing the number of bits in the neural code for optimal data compression, achieving a high level of encryption, achieving a lossless compression, achieving a particular mathematical transform of the data, or achieving a specific cognitive target output.

The operation of the neurosynaptic computer can thus include setting the hyperparameters of each component of the neurosynaptic computer. Such a setting of hyperparameters performs a function in a neurosynaptic computer that is similar to the function performed by programming paradigms and models in conventional computing. Further, hardware infrastructure and software can be specifically optimized for the diverse computations that need to be performed to operate a neurosynaptic computer.

As discussed above, series of steps and components can be part of a neurosynaptic computer. These include an encoding scheme for entering data into the neurosynaptic computer (akin to a sensory system), an architecture that can produce a large and diverse universe of computations (e.g., a recurrent artificial neural network BPU), a process to select and connect a subset of these computations to construct cognitive processes (a cognition system), a process to interpret the encoded cognitive processes (an action system) and a system to provide optimization and self-learning (a learning system). A recurrent artificial neural network brain processing unit generates a range of computations during a neural network's response to input. The brain processing unit can be a spiking or non-spiking recurrent neural network and can be implemented on a digital computer or implemented in specialized hardware. In principle, a neurosynaptic computer can be used as a general purpose computer or as any number of different special purpose computers such as an Artificial Intelligence (AI) computer or an Artificial General Intelligence (AGI) computer.

The computing paradigm of the neurosynaptic computer uses a hierarchy of elementary decisions organized into a hierarchy of unitary decisions, a hierarchy of cognitive operations, and a hierarchy of cognitive functions to produce a cognitive algorithm. The process begins with elementary decisions that are entangled to capture elementary computations performed by topological elements. Elementary decisions are entangled to construct unitary decisions. Unitary decisions are entangled in successive hierarchies to construct arbitrarily complex cognitive algorithms.

In principle, unitary decisions can be made at any level that a topological element can be defined, from the smallest component of the brain computing unit (e.g. molecules) through to larger components (e.g. neurons, small groups of neurons) to even larger components (e.g. large groups of neurons forming areas of the brain computing unit, regions of the brain computing unit, or the complete brain computing unit). The simplest version of the computing paradigm is where a topological element is defined as a network of the same type of component (e.g., neurons) and the most complex version of the paradigm is where the topological elements are defined as a network of different components (e.g. molecules, neurons, groups of neurons, groups of neurons of different sizes). Connections between topological elements allow associations that drive a process called entanglement. The recurrent connectivity between topological elements (e.g., between neurons in the simplest case and between molecules, neurons and groups of neurons, in a more complex case) specifies their associations and hence how unitary decisions can be entangled to form cognitive processes and how these unitary cognitive processes can be entangled.

A unitary decision is as any measurable output of a computation performed by any topological element. For example, a supra-threshold binary spike (i.e., an action potential) generated after integration of multiple sub-threshold inputs (e.g., synaptic responses) is a measurable output. A spike can therefore be considered a unitary decision. Any combination of spikes by any group of neurons can also be considered a unitary decision.

Topological elements—activated by an input directly and/or indirectly by other responding topological elements—produce a range of computations as a function of time when processing the input. The maximal size of the range of computations is determined by the number of topological elements. Any neural network generates a range of computations that ranges from uniform to maximally diverse. If the computations performed by the topological elements are identical, the range of computations is said to be uniform. If, on the other hand, the computations performed by each topological element is different, the range is said to be diverse. The complexity of the computation performed by a topological element is determined by the complexity of its structural and functional properties. For example, a neuronal node with an elaborate dendritic arborization and a given combination of non-linear ion channels on their arbors performs a relatively complex computation. On the other hand, a neuronal node that has a minimal dendritic arborization and only non-linear ion channels that are required to generate a spike performs a simpler computation.

The complexity of the computation performed by a topological element is also dependent on time. Generally, the complexity of any unitary computation is said to evolve towards peak complexity as a function of the time allowed for the components of the topological element to interact, which in turn is a function of the types of components, nature of their interactions, and time constants of their interactions. A decision can be made at any stage of this evolution of the computational complexity, terminating further evolution of the complexity of the computation involved in forming a unitary decision.

Where the structural and functional properties of topological elements vary quantitatively, they are said to produce variants of the computations within the same class of computation. On the other hand, topological elements where the structural and functional properties vary qualitatively, they are said to produce different classes of computations. The nature of the range of computations can be engineered in a process that includes selecting the number of classes of computation by selecting topological elements with qualitatively different structural and functional properties, setting the size of each class by introducing multiple representations of the same class of topological element, introducing variants in computations within a class of computation by selecting variants of topological elements within the same class, and setting the diversity within a class by selecting multiple representatives of topological elements within each class.

Neurosynaptic computing does not depend on knowledge or even the ability to derive the nature of the computations performed by topological elements. Instead, neurosynaptic computing is based on the premise that computations defined in this manner are sufficiently precise to form a unitary decision. It follows then that a range of computations is equivalent to a range of unitary decisions made in response to an input.

The nature of any unitary decision only becomes defined through its association with other unitary decisions. Topological elements, unitary computations, and unitary decisions are associated through the recurrent connectivity of a network. The associations define all the ways that the computations performed by topological elements can become entangled with other computations performed by other topological elements—i.e., the number possible entangled states of a topological element. Becoming entangled amounts to developing a dependent variable input from the computation performed by another topological element. The dependency can be arbitrarily complex. The state of entanglement of any one topological element becomes defined at every moment that a decision is made during the processing of the input and the state of entanglement is undefined, uncertain between decisions. The number of different entangled states of any one topological element is very large because of the existence of a large number of loops within loops characteristic of a recurrent network. The number of states of entanglements is also a function of the time required to reach a unitary decision (e.g., the time taken for a neuron to spike after the input in the case where a topological element is defined as a single neuron or the time taken for a specific sequence of spikes to occur in the case where a topological element is defined as a group of neurons).

Once a topological element has made a decision, the computation is said to have been completed. The time at which a computation reaches completion is referred to as a unitary decision moment. A brain processing unit that is responding to an input makes an integrated decision at the time when a set of a unitary decisions is made. Such a time when a set of a unitary decisions is made can be referred to as a unitary cognition moment. A cognition moment defines the cognitive processing of the input during the simulation of the neural network.

The entangled state of a topological element becomes defined when a unitary decision is made. The class of possible entangled states for a topological element is also constrained by the position of a topological element in the network, where the position is defined by the connectivity of a topological element to all other topological elements in the network. Positions of topological elements—and hence classes of entangled states for topological elements—are said to be maximally diverse if each topological element is uniquely connected to all other topological elements. A simple network topology where connectivity tends towards uniformity therefore yields topological elements with classes of entangled states that tend towards uniformity, while more complex network topologies yield networks with more diverse classes of entangled states.

The size and diversity of the range of computations and the number of classes of entangled states determines the computational capacity of a neurosynaptic computer. Provided that the range of computations is sufficiently large and the classes of computations and entangled states are sufficiently diverse, there exists a subset of computations and state of entanglement that can mimic any cognitive process, and thus enable universal cognitive computing.

The process of selecting the set of topological elements that form cognitive processes is an optimization function that finds a small subset of decisions involved in the cognitive process. The optimization function begins by finding a small subset of decisions being made that form a unitary cognitive process. The topological elements found are then used as a hierarchical constraint in the selection of additional topological elements to construct a cognitive process, and this set of topological elements are in turn used as a constraint to select a further subset of topological elements that emulates cognitive processes. This entanglement process can be referred to as a topological entanglement algorithm.

To practically exploit this theory for computing, unitary decisions made by topological elements are assigned a symbolic value. In the simplest implementation, a single bit is used to indicate whether a unitary decision has been made (“1”) or not (“0”). These bits can be referred to as neural bits (nBits). A set of nBits can be selected from the universe of nBits to represent a unitary cognitive process. The final hierarchical set of nBits is referred to as a neural code for cognition. In other implementations, the unitary decisions are represented by real numbers (nNums) to indicate the extent to which, and/or the confidence in the decisions being made by the topological elements. For example, the fraction of neurons spiking in a group of neurons selected as a topological element can be assigned to reflect the probability that a decision is made. In another implementation, the neural code is made up of a mixture of nBits and nNums representing the decisions made. And in another implementation, a set of metadata values such as those describing global graph properties reflecting global features of decision making across the network, are used as a constraint to guide the hierarchical selection of the topological elements making the relevant decisions and hence in the construction of the neural code. The metadata can also be added to the neural code to facilitate unentangling of a set of cognitive process, unitary cognitive processes, and unitary decisions.

Unentangling the neural code to produce an output or action can be achieved by recapitulating the entanglement algorithm. In one implementation, a set of machine learning models (first level models) is applied to the neural code and trained to decode the unitary cognitive processes, then another set of machine learning model (second level models) is applied to the neural code and the outputs of first level models are also used to decode the cognitive process, and then another set of machine learning models, (third level models) is applied to the neural code, the outputs of first and second level models are additionally used to decode the cognitive processes. This unentanglement can be implemented as a graph where the nodes are machine learning models and the edges are the inputs received from other machine learning models. This allows for arbitrarily complex unentanglement algorithms. An alternate implementation is to learn the graph used for unentangling the neural code. Another implementation is where an analytic formulation is applied to each stage of unentanglement. The output is referred to as an action and is comprised of a reconstruction of the original input, a construction of any number of mathematical transform functions of the original input, and any number of cognitive outputs.

Embodiments of the subject matter and the operations described in this specification can be implemented in analog, digital, or mixed signal electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include analog circuitry, mixed signal circuitry, or special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Although this specification contains many specific implementation details, these should not be construed as limitations on the scope of any inventions or of what may be claimed, but rather as descriptions of features specific to particular embodiments. Certain features that are described in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims.

1. A method for constructing nodes of an artificial recurrent neural network that mimics a target brain tissue, the method comprising:
setting a total number of nodes in the artificial recurrent neural network;
setting a number of classes and sub-classes of the nodes in the artificial recurrent neural network;
setting structural properties of nodes in each class and sub-class, wherein the structural properties determine temporal and spatial integration of computation as a function of time as the node combines inputs;
setting functional properties of nodes in each class and sub-class, wherein the functional properties determine activation, integration, and response functions as a function of time;
setting a number of nodes in each class and sub-class of nodes;
setting a level of structural diversity of each node in each class and sub-class of nodes and a level of functional diversity of each node in each class and sub-class of nodes;
setting an orientation of each node; and
setting a spatial arrangement of each node in the artificial recurrent neural network, wherein the spatial arrangement determines which nodes are in communication in the artificial recurrent neural network.

2. The method of claim 1, wherein the total number of nodes in the artificial recurrent neural network mimics a total number of neurons of a comparably sized portion of the target brain tissue.

3. The method of claim 1, wherein the structural properties of nodes include a branching morphology of the nodes and amplitudes and shapes of signals within the nodes, wherein the amplitudes and shapes of signals are set in accordance with a location of a receiving synapse on the branching morphology.

4. The method of claim 1, wherein the functional properties of nodes include subthreshold and suprathreshold spiking behavior of the nodes.

5. The method of claim 1, wherein the number of classes and sub-classes of the nodes in the artificial recurrent neural network mimics a number of classes and sub-classes of neurons in the target brain tissue.

6. The method of claim 1, wherein the number of nodes in each class and sub-class of nodes in the artificial recurrent neural network mimics a proportion of the classes and sub-classes of neurons in the target brain tissue.

7. The method of claim 1, wherein the level of structural diversity and the level of functional diversity of each node in the artificial recurrent neural network mimics diversity of the neurons in the target brain tissue.

8. The method of claim 1, wherein the orientation of each node in the artificial recurrent neural network mimics orientation of the neurons in the target brain tissue.

9. The method of claim 1, wherein the spatial arrangement of each node in the artificial recurrent neural network mimics spatial arrangement of the neurons in the target brain tissue.

10. The method of claim 9, wherein setting the spatial arrangement comprises setting layers of nodes and/or setting clustering of different classes or subclasses of nodes.

11. The method of claim 9, wherein setting the spatial arrangement comprises setting nodes for communication between different regions of the artificial recurrent neural network.

12. The method of claim 11, wherein a first of the regions is designated for input of contextual data, a second of the regions is designated for direct input, and a third of the regions is designated for attention input.

13. At least one computer-readable storage medium encoded with executable instructions that, when executed by at least one processor, cause the at least one processor to perform operations for constructing nodes of an artificial recurrent neural network that mimics a target brain tissue, the operations comprising:
setting a total number of nodes in the artificial recurrent neural network;
setting a number of classes and sub-classes of the nodes in the artificial recurrent neural network;
setting structural properties of nodes in each class and sub-class, wherein the structural properties determine temporal and spatial integration of computation as a function of time as the node combines inputs;
setting functional properties of nodes in each class and sub-class, wherein the functional properties determine activation, integration, and response functions as a function of time;
setting a number of nodes in each class and sub-class of nodes;
setting a level of structural diversity of each node in each class and sub-class of nodes and a level of functional diversity of each node in each class and sub-class of nodes;
setting an orientation of each node; and
setting a spatial arrangement of each node in the artificial recurrent neural network, wherein the spatial arrangement determines which nodes are in communication in the artificial recurrent neural network.

14. The at least one computer-readable storage medium of claim 13, wherein wherein the spatial arrangement of each node in the artificial recurrent neural network mimics spatial arrangement of the neurons in the target brain tissue.

15. The at least one computer-readable storage medium of claim 14, wherein setting the spatial arrangement comprises setting layers of nodes and/or setting clustering of different classes or subclasses of nodes.

16. The at least one computer-readable storage medium of claim 14, wherein setting the spatial arrangement comprises setting nodes for communication between different regions of the artificial recurrent neural network.

17. The at least one computer-readable storage medium of claim 16, wherein a first of the regions is designated for input of contextual data, a second of the regions is designated for direct input, and a third of the regions is designated for attention input.
